(19) United States
(12) Patent Application Publication
(10) Pub. No.: US 2026/0350377 A1
(43) Pub. Date: Nov. 5, 2026

(54) SYSTEM AND METHOD FOR ARTIFICIAL INTELLIGENCE MODEL COMPRESSION AND OFFLINE OPTIMIZATION

(71) Applicant: Wasted Potential Studios LLC, Lockport, IL (US)

(72) Inventor: Joseph Ridder, Lockport, IL (US)

(73) Assignee: Wasted Potential Studios LLC, Lockport, IL (US)

(21) Appl. No.: 19/459,667

(22) Filed: Jan. 26, 2026

Related U.S. Application Data
(60) Provisional application No. 63/798,069, filed on May 1, 2025.

(51) Int. Cl. G06N 3/0495

(52) U.S. Cl. CPC G06N 3/0495

(57) ABSTRACT

A multi-tiered Artificial Intelligence (AI) model compression system includes a memory and a processor. The memory is configured to store simulation data of a simulation, wherein the stored simulation data comprises data relating to at least one player character and non-player character. The processor is configured to: create a base model of the simulation using the stored simulation data; compress the base model of the simulation via a weight clustering of trained parameter weights of the base model generated from the stored simulation data; receive textual and audio information relating to the simulation; tokenize the received textual and audio information to create a packet of information; input the packet of information into a run-time instance of the base model of the simulation; determine behavior responses of the at least one player character and non-player character based on the packet of information; and perform the simulation using the determined behavior responses.

### CROSS-REFERENCE TO RELATED APPLICATIONS

This application claims the benefit of U.S. Patent Application No. 63/798,069, filed May 1, 2025, which is hereby incorporated by reference in its entirety for all purposes.

### BACKGROUND OF THE INVENTION

Conventional Artificial Intelligence (AI)-driven non player character (NPC) systems depend on cloud-based processing or high performance local computing to handle complex decision-making. Such AI-driven NPC systems are not optimized for offline single-player gaming. Because such AI-driven NPC are not optimized, performance bottlenecks and excessive memory consumption can result.

### BRIEF SUMMARY OF THE INVENTION

A system and method for Artificial Intelligence (AI) model compression and offline optimization is described herein. The system provides complex artificial intelligence behaviors within an offline computing environment. The system includes a multi-tiered compression and inference model that provides efficient real-time AI decision-making without reliance on cloud-based architectures. The system facilitates an AI ecosystem capable of sustaining emergent behaviors, dynamic NPC interactions, and long-term memory retention while operating on resource-constrained consumer hardware.

In an aspect of the present disclosure, the system may be a multi-tiered Artificial Intelligence (AI) model compression system. The system can include a memory configured to store simulation data of a simulation. The stored simulation data can include data relating to at least one player character and non-player character. The system can include a processor. The processor can be configured to: create a base model of the simulation using the stored simulation data; compress the base model of the simulation via a weight clustering of trained parameter weights of the base model generated from the stored simulation data; receive textual and audio information relating to the simulation from at least one of (i) a simulation engine executing the simulation and (ii) a user input device; tokenize the received textual and audio information to create a packet of information of the received textual and audio information; input the packet of information into a run-time instance of the base model of the simulation; determine behavior responses of the at least one player character and non-player character based on the packet of information input into the run-time instance of the base model; and perform the simulation using the determined behavior responses.

In an aspect of the present disclosure, the base model of the simulation can be created via at least one of (1) determining an efficient inference via a model distillation, (2) determining efficient training via a low-rank adaptation (LoRA), (3) determining reduced size via a quantization, (4) determining lower memory usage via a sparse attention, and (5) determining activation costs via adaptive caching.

In an aspect of the present disclosure, the processor can be configured to parallelize the compressed base model. Parallelizing of the compressed base model can include sharing model parameters and distributing inference computations across a plurality of processors using at least one of model-parallel execution and data-parallel execution to reduce inference latency for generating the behavior responses.

In an aspect of the present disclosure, the compressing of the base model of the simulation and the parallelizing of the compressed base model can be performed for multiple iterations.

In an aspect of the present disclosure, the parallelizing of the compressed base model can include partitioning transformer blocks across multiple graphic processing units (GPUs).

In an aspect of the present disclosure, each of the behavior responses of the one or more characters of the simulation can be independently determined.

In an aspect of the present disclosure, the run-time instance of the base model of the simulation can include information that may be unique and/or isolated from other run-time instances of the simulation.

In an aspect of the present disclosure, the tokenizing of the received textual and audio information can create a single packet of information of the received textual and audio information.

In an aspect of the present disclosure, the processor can be configured to determine behavior responses of the at least one player character and non-player character based on the packet of information input into the run-time instance of the base model of the simulation.

In an aspect of the present disclosure, the weight clustering can include assigning multiple neural node weights to clusters each represented by a shared centroid weight value.

In an aspect of the present disclosure, the textual and/or audio information can correspond to utterances and context data of the at least one player character and non-player character. The utterances and context data can include observations, world state variables, and/or requested actions of the at least one player character and non-player character.

### BRIEF DESCRIPTION OF THE SEVERAL VIEWS OF THE DRAWINGS

The foregoing summary, as well as the following detailed description of the exemplary embodiments of the invention, will be better understood when read in conjunction with the appended drawings. For the purpose of illustrating the invention, there are shown in the drawings embodiments, which are presently preferred. It should be understood, however, that the invention is not limited to the precise arrangements and instrumentalities shown.

FIG. 1 illustrates a block diagram of a system in accordance with embodiments of the present invention;

FIG. 2 illustrates a block diagram of an artificial intelligence (AI) subsystem of FIG. 1, in accordance with embodiments of the present invention;

FIG. 3 illustrates a block diagram of a non-player character (NPC) subsystem of FIG. 1, in accordance with embodiments of the present invention;

FIG. 4 illustrates a block diagram of an optimization subsystem of FIG. 1, in accordance with embodiments of the present invention;

FIG. 5 illustrates a block diagram of an AI model architecture of the AI subsystem of FIG. 2, in accordance with embodiments of the present invention;

FIG. 6 illustrates a block diagram of a model architecture of FIG. 1, in accordance with embodiments of the present invention;

FIG. 7 illustrates a block diagram of a computational infrastructure of FIG. 1, in accordance with embodiments of the present invention;

FIG. 8 illustrates a block diagram of stages of a progressive training framework of FIG. 1, in accordance with embodiments of the present invention;

FIG. 9 illustrates a method of using system of FIG. 1, in accordance with embodiments of the present invention;

FIGS. 10-13 illustrates example screenshots of simulations provided via the system of FIG. 1, as described herein; and

FIG. 14 illustrates a block diagram of a component system for performing a simulation according to the system of FIG. 1, in accordance with embodiments of the present invention.

### DETAILED DESCRIPTION OF THE INVENTION

Reference will now be made in detail to the various embodiments of the subject disclosure illustrated in the accompanying drawings. Wherever possible, the same or like reference numbers will be used throughout the drawings to refer to the same or like features. It should be noted that the drawings are in simplified form and are not drawn to precise scale. Certain terminology is used in the following description for convenience only and is not limiting. Directional terms such as top, bottom, left, right, above, below and diagonal, are used with respect to the accompanying drawings. The term “distal” shall mean away from the center of a body. The term “proximal” shall mean closer towards the center of a body and/or away from the “distal” end. The words “inwardly” and “outwardly” refer to directions toward and away from, respectively, the geometric center of the identified element and designated parts thereof. Such directional terms used in conjunction with the following description of the drawings should not be construed to limit the scope of the subject disclosure in any manner not explicitly set forth. Additionally, the term “a,” as used in the specification, means “at least one.” The terminology includes the words above specifically mentioned, derivatives thereof, and words of similar import.

“About” as used herein when referring to a measurable value such as an amount, a temporal duration, and the like, is meant to encompass variations of ±20%, ±10%, ±5%, ±1%, or ±0.1% from the specified value, as such variations are appropriate.

“Substantially” as used herein shall mean considerable in extent, largely but not wholly that which is specified, or an appropriate variation therefrom as is acceptable within the field of art. “Exemplary” as used herein shall mean serving as an example.

Throughout this disclosure, various aspects of the subject disclosure can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments of the subject disclosure may be combined in any suitable manner in one or more embodiments. One skilled in the relevant art will recognize, in light of the description herein, that the present disclosure can be practiced without one or more of the specific features or advantages of a particular exemplary embodiment. In other instances, additional features and advantages may be recognized in certain embodiments that may not be present in all exemplary embodiments of the subject disclosure.

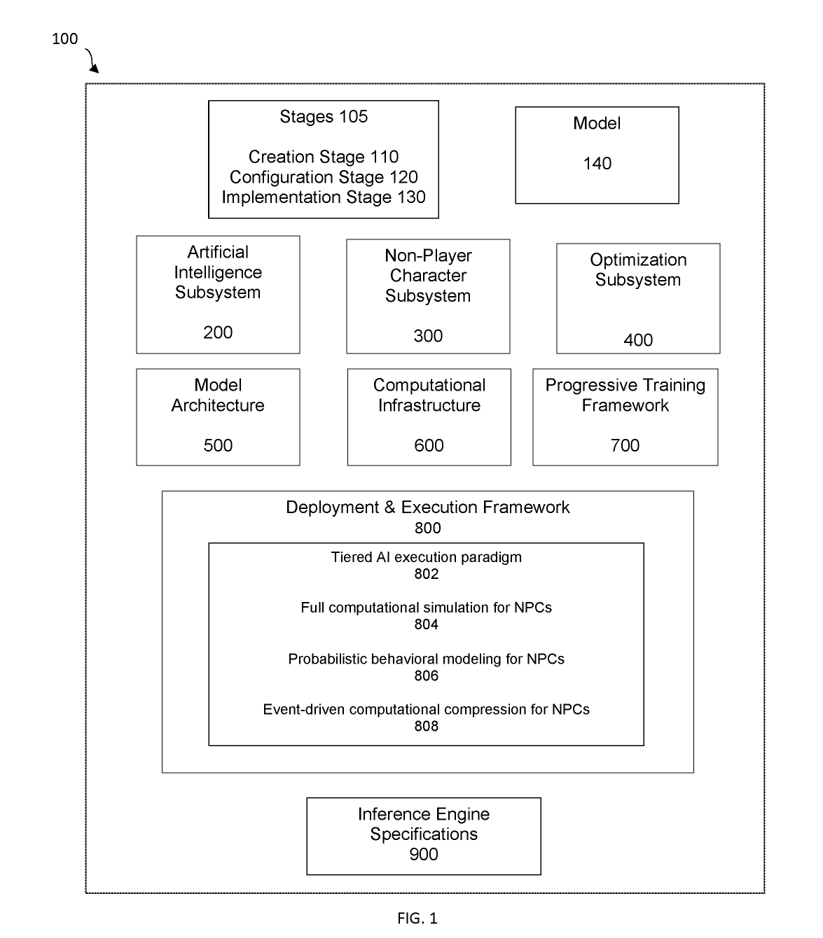

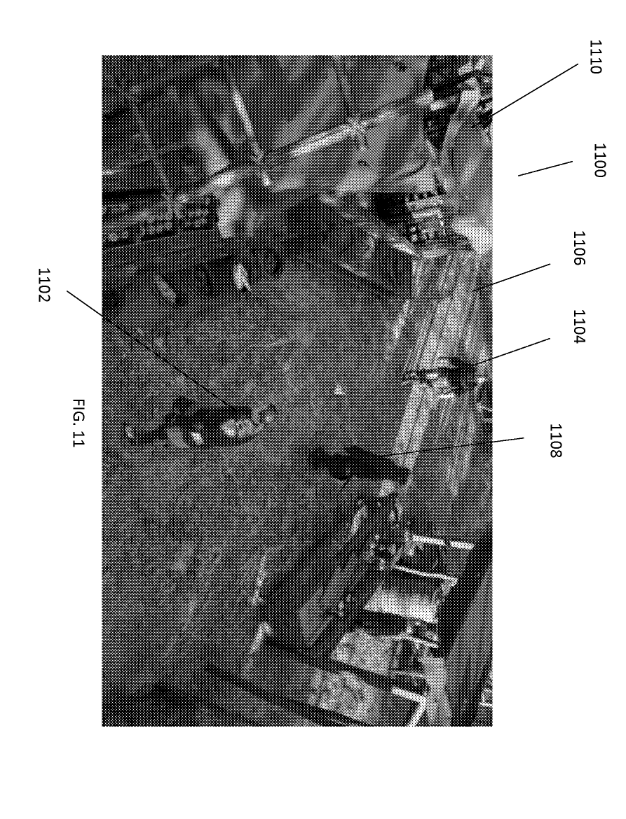

FIG. 1 illustrates a system 100 that provides one or more features as described further herein. The system 100 can provide simulations that include hyper-realistic human behavior. Example simulations include simulations shown in FIGS. 10-13, as described herein. The system 100 can include an artificial intelligence (AI) framework that manages one or more characters and/or agents in a simulated space. In an embodiment, the simulated space can be a hyper-realistic simulated space that can be rendered in Unreal Engine. The artificial intelligence framework can merge adaptive learning, emotional intelligence, and dynamic memory into a real-time architecture. In an embodiment, the real-time architecture can be offline (e.g., fully offline, without cloud dependency). The AI framework can be used to power lifelike autonomous characters and/or agents that are capable of realistic behaviors and nuanced interactions. The characters and/or agents can be used to transform interactive storytelling, training simulations, and gaming, for example.

The AI framework can utilize one or more programmatic techniques and artificial intelligence models to produce a simulated experience of human-like reaction. To support the illusion of human-like behavior (e.g., in simulations featuring multiple actors, such as ancient actors), one or more of the following criteria can be provided: fast responses, high variety, and generalized reasoning. Fast responses can be provided as latency can be minimal to simulate the real-time responses of human reaction and dialogue. High variety can be provided because the simulations should be able to express a wide number of characteristics consistent with real-world personality profiles at a real-world distribution level. Generalized reasoning can be provided because the simulated agent actors should be able to reason at a level comparable to average human intellect, and behave in response to those generalizations.

Providing fast responses, high variety, and generalized reasoning can present a problem for simulation creators. Although large language models may be desired in artificial intelligence systems because of their ability to produce human-comparable language in contextually relevant ways, such models can prove insufficient for actual human-like presentations because it may be impractical to reproduce features such as human error and limited perception to products designed to augment such limitations in human cognition. For example, the system 100 can provide imperfection to simulations. The system 100 addresses the need of human-like decision making being based on human-like limitations. Because of the use cases for this in individual PC gaming, bespoke training, simulations, and sensitive use cases (e.g., in which the model is trained on classified or protected data such as in defense scenarios), the model provided of the system 100 should be able to run on local machines, on-premises, and without cloud access.

The system 100 can include one or more stages 105 including a creation stage 110, a configuration stage 120, and an implementation stage 130. During the creation phase 110, the model 140 (e.g., core model) of the simulation can be trained for a specific use case. The training elements can be common to one or more types of transformer models and training pipelines. The configuration of the elements can be specific to a use case and a desired result. The configuration of the elements can include a curation and a preparation of training data. A core reasoning model can be a monolithic multimodal feed-forward self-attention transformer model. In an example, the core reasoning model can be in a same class of models as ChatGPT, Mistral, Llama, and Gemini.

The system 100 can include (e.g., require) one or more features, such as one or more early exit pathways for intuitive reasoning, different modality combinations (e.g., the ability to input text, produce audio, input images, and produce text, from the same model with shared internal caching), a feed-forward Network for shared and related inference paths, and encoding for input and output embeddings. Features of the system 100 can include generalizable reasoning opportunities based on dataset coherence and strong neural node weights. Features of the system 100 can make the model 140 (e.g., transformer model) unique from other models (e.g., foundational models) and can require a specific training pipeline. Also, since the model 140 (e.g., transformer model) used by the system 100 can run on premise (e.g., not in the cloud), efficiencies to energy, computations, and memory optimizations can be provided to provide fast, low-latency inferences with high-quality and diverse generative responses.

The model 140 run by the system 100 can be a dense model that can be compressed using one or more techniques. In embodiments, the model 140 can be compressed via a weight clustering, a pipeline technique, and the like. For example, the base model of the simulation can be compressed via a weight clustering of trained parameter weights of the model 140 generated from the stored simulation data. The weight clustering can include assigning one or more (e.g., multiple) neural node weights to clusters each represented by a shared centroid weight value. The pipeline technique can include one or more of data set curing, pre-process and feature engineering, encoding of one or more datasets, transformer pre-training, domain-specific fine tuning, optimization, distillation, quantization, and weight clustering.

Data can be received via one or more entities, such as simulation (e.g., a simulation engine executing the simulation), user input, one or more other simulations and/or external sources, and the like. The data that is received can include textual data, audio data, and the like. In an embodiment, the textual and audio information can correspond to utterances and context data of one or more player characters and/or non-player characters of the simulation. Utterance and context data can include observations, world state variables, and requested actions of the player character(s) and non-player character(s).

In an example, the received textual and audio information can be tokenized. In an example, tokenizing of the received textual and audio information can create a packet (e.g., single packet) of information of the received textual and audio information. The packet of information can be input into a run-time instance of the base model (e.g., the base model of the simulation). Behavior responses of the player character(s) and/or non-player character(s) can be determined (e.g., independently determined). Each of the behavior responses of the player character(s) and non-player character(s) can be independently determined based on the packet of information input into the run-time instance of the base model. In embodiments, the run-time instance of the base model of the simulation can include information that is unique and/or isolated from one or more other run-time instances of the simulation. Behavior responses of the player character(s) and non-player character(s) can be determined based on the packet of information input into the run-time instance of the base model of the simulation. The simulation can be performed via system 100 via the determined behavior responses, as described herein.

The data can form one or more data sets. The data and/or data set curing can be performed that includes and/or requires dense and coherent data across one or more (e.g., all) modalities, such as text, image, audio, and the like. The curation of relevant data (e.g., the most relevant data) can be performed with low noise (e.g., the least noise possible) to reduce neural connections and/or provide enough context for diverse reasoning. Pre-processing and feature engineering can be performed using intensive data science labor for large data sets (e.g., across multimodal training). Encoding dataset(s) and converting dataset(s) into shared embeddings across all modalities within the model's internal space can be performed. Transformer pre-training can be performed using a self-attention technique, such as a self-attention technique used for transformer models.

Domain-specific fine-tuning, which can be unique to each use case and simulation, can be performed. Domain-specific fine-tuning can control the output (e.g., exact output) and/or consistency of the data. Optimization can be performed that includes retraining until critical benchmarks are reached in performance. Distillation can be performed using the large model produced from one or more techniques to train a smaller model (e.g., on desired input and output), which can produce a smaller and more efficient model. Quantization can be performed that can reduce parameter precision to reduce the required memory and computations for inference without sacrificing the quality of generative output. Weight clustering can be performed as a compression technique (e.g., final compression technique). Weight clustering can combine constellations of connected node weights to reduce size and/or increase inference without reducing accuracy.

Upon completion of one or more of the above techniques, the model 140 can be made smaller. The smaller model can be fast enough to run on consumer-grade hardware without an unreasonable footprint. The model can be made more accurate with iterative pruning, which can remove weights based on a criteria, such as weights that are rarely activated in production. The iterative pruning can reduce noise within the model, reduce the size of the model, and reduce generalization.

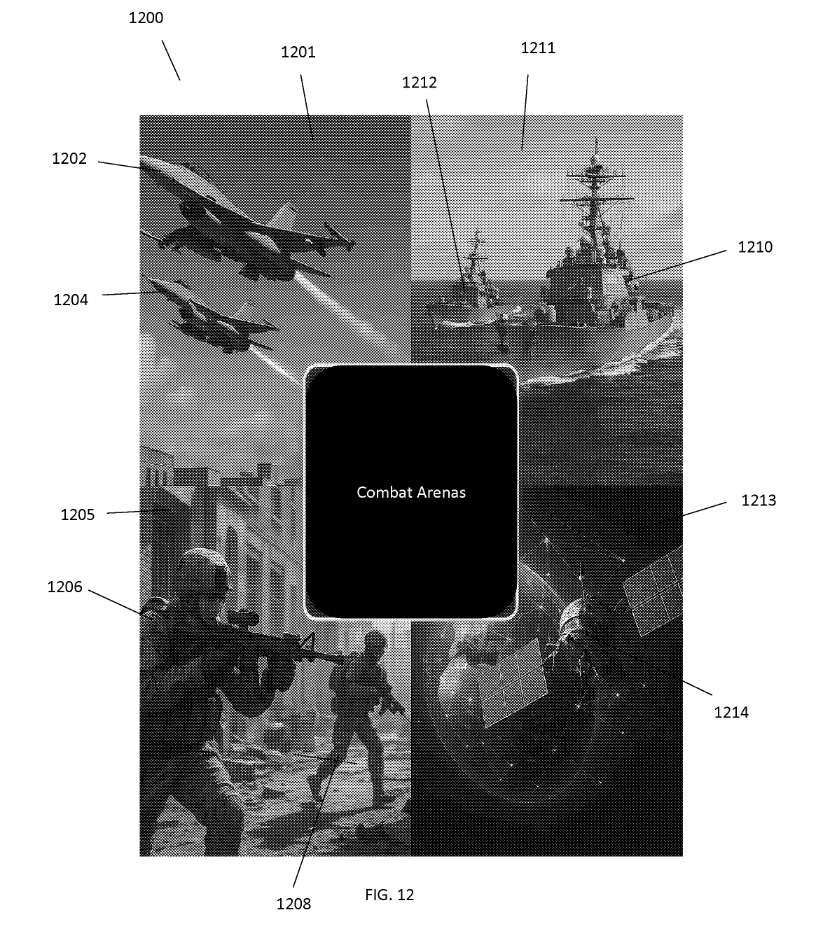

During the configuration stage 120, the system 100 can be built around internal profile mechanisms. Interim profile mechanisms can include one or more of a model of mind involving a series of traits informed by existing psychology, a series of behaviors relevant to actions within the simulation, and in-house heuristics to relate the two mechanisms. The configuration stage 120 can be informed by the use case of the simulation, similar to the data set. For example, a configuration within a medieval kingdom simulation (FIGS. 10, 11) can include actions and behaviors expected of agent actors in that scenario, such as responses to illness corresponding to common understandings prior to germ theory. A configuration within a flight simulator can have behaviors specific to the trained and learned control operations of a fighter jet (FIG. 12). Psychological profiles can be unchanged across simulation scenarios. Heuristics can be adjusted and reach accurate performance benchmarks suitable to the use case of the simulation.

The implementation stage 130 of the system 100 can have one or more moving parts, such as the model 140 (e.g., a base model). In an example, the base model can be created using data, such as data stored by the simulation data. The base model of the simulation can be created via one or more of determining an efficient inference via a model distillation, determining efficient training via a low-rank adaptation (LoRA), determining reduced size via a quantization, determining lower memory usage via a sparse attention, and determining activation costs via adaptive caching, as described herein. The base model can provide core reasoning within agent actors. One or more other models can be used within the ecosystem of the system 100. Access to the models can be controlled by heuristics adjusted in the configuration stage for low latency, low compute, and/or human-like behavior.

The implementation stage 130 can include one or more models 140, such as one or more habitual models, utterance models, behavioral models, and reasoning models. The habitual model can be represented by Markov, graph systems, and/or k-nearest models. The habitual module can produce habitual actions based on current states, which can represent semi-conscious actions within the agent actor. The utterance model can use a recurrent neural network (RNN) model and produce fast, common, high variety, but low inference utterances (e.g., turning a phrase, cliches, habitual dialogue responses, and context). The utterance model can provide accurate filler words, such as default approvals or disapprovals (e.g., yes and no), and default commands. The filler words (e.g., accurate filler words) used by the utterance model can be consistent with those provided by the higher-level reasoning of the core model, but may be reduced to a smaller decision space.

The behavioral model can use state engines (e.g., Mamba). The behavior model can produce fast chains of state-based behavioral sequences for activities, such as complex activities that require chains of goal-oriented and contextually constrained actions. Producing fast chains of state-based behavioral sequences for activities can be used for combat decision making, or for communicative behaviors such as body language or facial expressions.

The reasoning model can control dialogue and/or strategic and generalized inferences. Other models can use continuous training systems to be informed by the reasoning model, which can keep the models consistent. For example, continuous learning can be used in sub-models. In an embodiment, continuous learning can be throttled by various heuristic filters that can be defined in the configuration stage. For example, acting from a reasoned inference may not produce a subsequent default and can produce behaviors and actions within a cluster of similarity. Thresholds of repetition can become a default or habitual behavior and/or action, and can mimick human behavioral change(s).

Along with the curation of data in the semi-generalized multimodal system, the system 100 can provide a human behavioral model with simulated emotional intelligence and context awareness. Because of the ability of the system 100 to link events (e.g., simultaneous events) in agent actor memory, the system 100 can produce opportunities for unique and individual generalizations in reasoning. For example, large language models (LLMs) may not reason in a conventional sense. LLMs can utilize pattern recognition across statistical predictions to produce chains of reasoned output based on linguistic distributions. For novel situations within the simulation, the system 100 can create generalized links between thoughts. As an example, the generalized links can be based on individual experiences and can produce collaborative generalizations using the wisdom-of-crowds in a society of mind AI model through the multi-agent experience. Producing collaborative generalizations using the wisdom-of-crowds in a society of mind AI model through the multi-agent experience can provide a unique opportunity for human-like collaboration.

Input into each of the models can be throttled and/or filtered based on context. For example, time to reason, high stamina, and/or being in a safe place may take time to use a chain of reasoning and a higher scope of information to produce more thorough generations of decisions or dialogue. A non-player character (NPC) in a lower state of safety and/or with limited stamina can have a reduced filter of input through which to make reasoning, a lower inference window, and/or a lower generative temperature (e.g., a parameter used to determine stochastic creativity and transformer models) available, which can represent human equivalent urgency in decision making and can (e.g., based on predefined heuristics per each agent and/or actor) represent as flight or fight, or produce more habitual responses, which can result in agents being trained in real time within a simulation and perform differently based on their training, providing opportunities for simulations of different training styles for leaders.

The filtration of the input into each of the models can manage inference. In an embodiment, GPU utilization with dense inputs and high computational outputs across a field can be crippling. The level of detail-based approach provided by the system 100 can allow one or more agent actors to utilize (e.g., internally utilize) and manage the computing needs of the agent actors and to bargain for resources with the graphics rendering engine of the simulation. The curated level of data can be further optimized through a multi-layer system of filtering and compression. For example, agent actors can have fields of vision and areas of audio perception. World memory can be limited to the objective states of the rendered persistent environment. Past history can be logged in the individual agent actor, and pruned based on subjective impact over time, which can produce long-term and short-term memory categories and retain historical world data that was observed, which can determine reduced storage footprints that can be self-managing and deliver constrained hyper realism.

The players and agent actors of the simulation of the system 100 can share rendered information. In an exemplary embodiment, relevant information (e.g., only relevant information) can be processed by one or more agent actors based on the individual context of each agent actor. Each actor can have its own persistent internal state, which can be prospectively based and separate from the world state and the internal state of other agent actors, which can force creativity, collaboration, and communication within human constraints rather than scripted top-down simulations.

In long-lasting memory critical simulations, the framework provided in the system 100 can allow for the pruning of individuals that are terminated, which can result in the terminated individual’s world state being inaccessible to any part of the simulation. Having the terminated individual’s world state being inaccessible to any part of the simulation can represent the removal of subjective internal states at the time of death in the real world, which can indicate that intelligence is limited to shared objective states in the simulation. Having the terminated individual’s world state being inaccessible to any part of the simulation can preserve storage for the simulation, as archiving dead simulated ancient actors without specific needs for retraining for future iterations would be unnecessarily expensive.

In situations in which the data would continue to be valuable, future iterations of simulations can learn and increase in difficulty using selective pruning via memory logs from existing or terminated agent actors to retrain weights in the core model. Such process may not be done during the simulation, but instances or iteration of training and pruning may be necessarily computationally intensive operations.

As shown in FIG. 1, the system 100 can include one or more systems or subsystems, such as one or more Artificial Intelligence (AI) Subsystems 200, Non-Player Character (NPC) Subsystems 300, Optimization Subsystems 400. Model Architectures 500, Computational Infrastructures 600, Progressive Training Frameworks 700, and Deployment Execution Frameworks 800. The one or more systems or subsystems within the system 100 can be fully offline in an embodiment, although in other embodiments the one or more systems or subsystems can be online. In examples in which the systems or subsystems are offline (e.g., fully offline) the systems of subsystems may have no reliance on cloud computing.

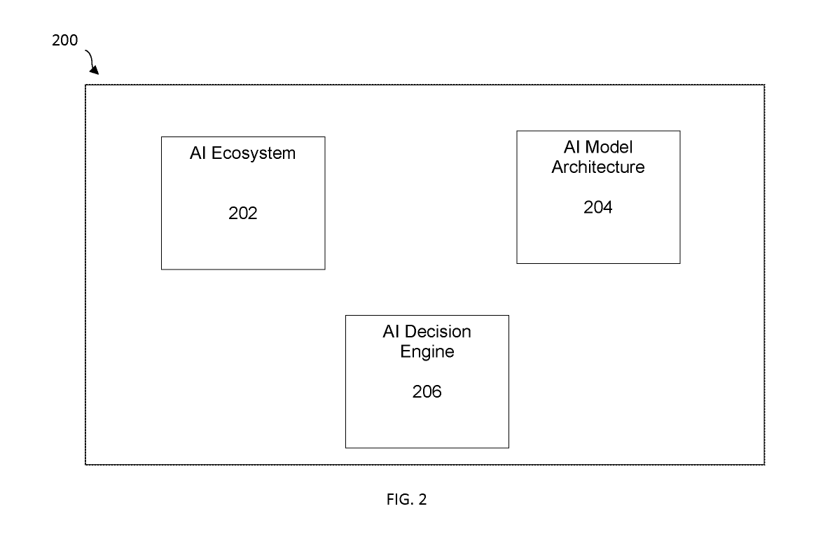

As shown in FIG. 2, the AI subsystem 200 can include one or more subsystems, such as an AI Ecosystem 202, an AI Model Architecture 204, and an AI Decision Engine 206. The AI Ecosystem 202 can include an AI runtime layer, such as a local AI runtime layer. The AI runtime layer can coordinate model invocation, agent-context assembly, response interpretation, and/or post-inference state updates. The AI runtime layer can provide an integration interface between the AI subsystem 200 and the NPC subsystem 300. The AI Ecosystem 202 can include a model runtime subsystem configured to load a model artifact (e.g., locally stored model artifact) into an in-memory model handle during initialization and can provide inference services to requesting components. The AI Ecosystem 202 can include an agent request interface configured to receive, from the NPC Simulation System 302 and/or an NPC controller of the NPC subsystem 300, a request context including observation data, world-state data, one or more action queries, one or more agent identifiers, and/or a tier indicator.

The AI Ecosystem 202 can include a prompt and context composer configured to generate a model-consumable inference input by combining (i) the request context, and (ii) agent-specific memory context retrieved from the self-adaptive NPC memory system 308. The AI Ecosystem 202 can include an inference control module configured to select an inference profile responsive to the tier indicator, which can include appending an inference-mode tag to the inference input when operating in a reduced inference mode. The AI Ecosystem 202 can include a response interpreter configured to parse inference output to extract one or more directives corresponding to dialogue output, action selection, and/or state transitions and to provide one or more directives to the NPC subsystem 300 for execution. The AI Ecosystem 202 can include an update pipeline configured to store interaction results for the agent identifier in the self-adaptive NPC memory system 308 and to trigger persistence operations via the Offline Data Storage and Query Optimization 402 of the Optimization Subsystem 400.

The AI model architecture 204 can provide expansive, detail-rich open-world interactions within a simulation that can provide real-time NPC decision-making. The AI model architecture 204 can enable high fidelity NPC behavior. As described herein, the AI model architecture 204 can execute offline (e.g., entirely offline). The high fidelity offline NPC behavior can include (e.g., can include in a launching game) the processing of verbal inputs, processing of contextual input based on NPC local area sensory data, basic reasoning and inference of the same, low latency and in character verbal response to verbal input, and triggering appropriate character actions (e.g., walking, emotes, and other state triggers) based on reasonings from previously mentioned contexts. In an embodiment the AI model architecture 204 can be compressed.

The AI model architecture 204 can provide high fidelity NPC behavior via one or more of a Low-Rank Adaptation (LoRA), Layer Pruning, Quantization, and Sparse Attention Mechanism(s). In an example Low-Rank Adaptation can include fine-tuning large AI models without redundant data storage. Layer Pruning can include removing redundant computational layers to improve efficiency. In an example the Quantization may be 4-bit and/or 8-bit precision and may reduce model storage requirements while retaining inference accuracy. Sparse attention mechanisms may focus AI processing on relevant game interactions, which may reduce overhead on the computing environment on which the system runs.

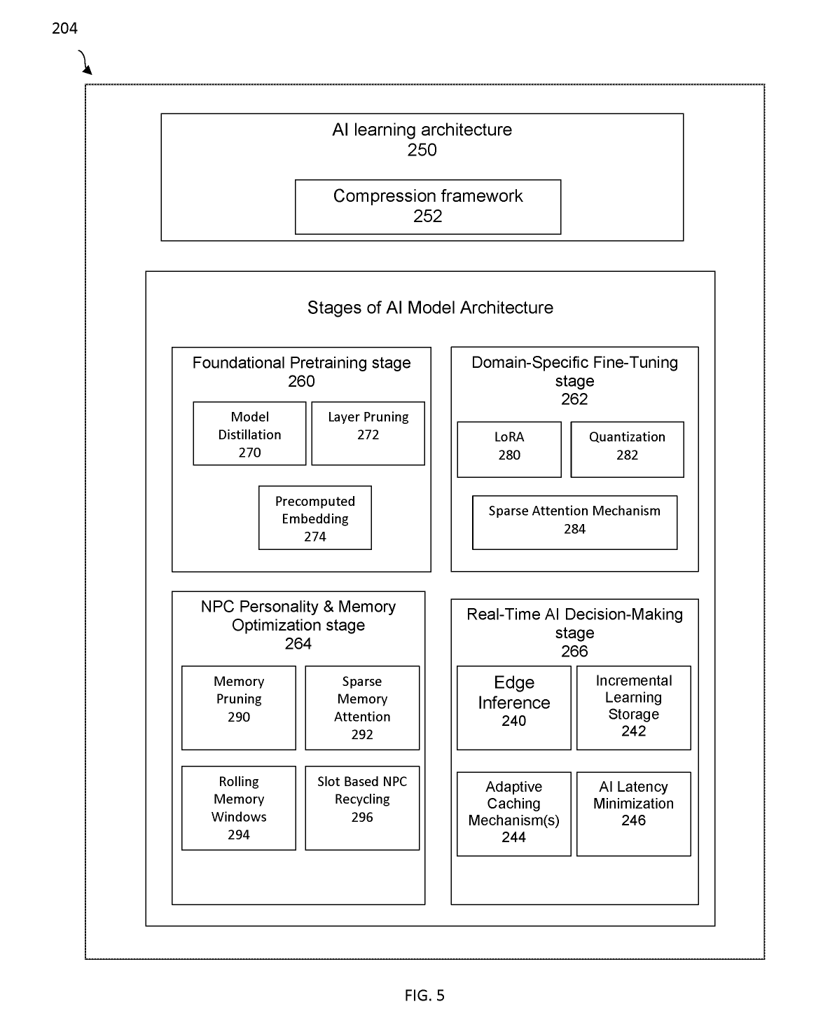

As shown in FIG. 5, the AI model architecture 204 can include an AI learning architecture 250. The AI learning architecture 250 can include a compression framework 252 that may be tiered and include multiple phases. In an embodiment, the compression framework 252 can optimize storage efficiency, computational throughput, and real-time inference while maintaining full offline operability.

As further shown in FIG. 5, the AI model architecture 204 can include one or more stages. In an embodiment, the stages can include one or more of a Foundational Pretraining stage 260, a Domain-Specific Fine-Tuning stage 262, an NPC Personality & Memory Optimization stage 264, and a Real-Time AI Decision-Making stage 266. Each stage of the AI model architecture 204 can incorporate one or more optimization techniques that can be distinct, which can include complex cognitive processes, long-term memory storage, and/or behavioral adaptations that can occur within computationally feasible limits.

Computationally feasible limits can include one or more enforceable constraints, such as one or more inference latency budgets, computational utilization budgets, concurrency budgets, context assembly budgets, memory footprint budgets, persistent I/O budgets, and degradation and recovery rules.

In an embodiment, an inference latency budget can include a maximum allowed time for generating an inference output for a request context so that simulation frame deadlines can be maintained and user-perceived responsiveness can be preserved. A computational utilization budget can include a maximum permitted CPU and/or GPU utilization that can be attributable to AI execution (e.g., inference, memory retrieval, and post-processing) to avoid contention with rendering and other simulation workloads. A concurrency budget can include a number (e.g., maximum number) of concurrently evaluated agents and/or concurrent inference requests permitted within a time window, such as a prioritization rule set for which agents receive full inference versus reduced inference.

A context assembly budget can include a maximum permitted size and complexity of the inference input assembled per request (e.g., world-state, observation content, and retrieved memory content), such that context preparation can be bounded in time and memory. A memory footprint budget can include a maximum permitted volatile memory allocation for agent memory, caches, and runtime AI state, such as per-agent and per-world caps that can prevent unbounded growth during long sessions. A persistence and I/O budget can include a maximum permitted disk I/O frequency and write volume that can be attributable to AI logging, memory persistence, and/or state updates, such that storage operations may not (e.g., do not) introduce stalls or bottlenecks. A degradation and recovery rule can escalation and/or de-escalation rules that transition agents between execution tiers and adjust inference detail, such as when one or more budgets are approached or exceeded, and that restore higher-fidelity execution when resources become available.

The first stage of the AI model architecture 204 can include the Foundational Pretraining stage 260. The Foundational Pretraining stage 260 can include large-scale knowledge acquisition(s) via unsupervised learning. The compression methodology used for the foundational pretraining 260 can include model distillation+, layer pruning, and the like. Offline feasibility for the foundational pretraining 260 can be provided due to the data being compressed (e.g., fully compressed).

As shown in FIG. 5, the Foundational Pretraining stage 260 can include one or more of a Model Distillation 270, a Layer Pruning 272, and a Precomputed Embedding 274. In Model Distillation 270, a compact AI surrogate can be trained using the response set of a larger foundational model, which can preserve reasoning capabilities while reducing storage overhead. In Layer Pruning 272, unnecessary computational layers can be excised from the neural architecture, which can improve processing efficiency without diminishing inferential accuracy. In Precomputed Embeddings 274, common linguistic constructs, decision pathways, and situational heuristics can be pre-indexed to accelerate response retrieval. In an embodiment, the Foundational pretraining stage 260 can reduce a significant amount of the model, such as 75% of a model size. Such reduction of the model size can consolidate storage overhead (e.g., can reduce storage to below 2GB), which can provide compatibility with consumer hardware.

As shown in FIG. 5, the second stage of the AI model architecture 204 can include the Domain-Specific Fine-Tuning stage 262. The Domain-Specific Fine-Tuning stage 262 can include context-aware adaptation for medieval world interactions. The compression techniques used for Domain-Specific Fine-Tuning stage 262 can include Low-Rank Adaptation (LoRA)+ 280, Quantization 282, Sparse Attention Mechanism 284, and the like. The Domain-Specific Fine-Tuning stage 262 can be executed offline due to the data used for the stage being optimized for inference.

In an embodiment, the Low-Rank Adaptation (LoRA) 280 can include fine-tuning enhancements. The fine-tuning enhancements can be applied via modular Adapters. The fine-tuning enhancements can preserve the pre-trained model's integrity while enabling game-specific knowledge integration. Quantization 282 can be 4-bit and/or 8-bit weights. The weight precision for the Quantization 282 can be reduced (e.g., dynamically reduced) to optimize memory allocation without impairing inferential fidelity. Sparse Attention Mechanisms 284 can include processing that is focused (e.g., solely focused) on relevant input tokens. Providing relevant input tokens can reduce or eliminate extraneous computational expenditure. For example, Domain-Specific Fine-Tuning 262 can result in a 3GB optimized model that is capable of executing sophisticated world-simulation logic while operating entirely offline.

The third stage of the AI model architecture 204 can include the NPC Personality & Memory Optimization stage 264. The NPC Personality & Memory Optimization stage 264 can provide context-driven AI decision-making, memory formation, and behavior modeling. The compression methodology for the NPC Personality & Memory Optimization stage 264 can include Memory Pruning+ 290, Sparse Memory Attention 292, Rolling Memory Windows 294, Slot Based NPC Recycling 296, and the like. The NPC Personality & Memory Optimization stage 264 can execute offline due to the data being offline (e.g., persistently offline).

The Memory Pruning 290 can include superfluous memory entries that can be culled (e.g., systematically culled). By culling the memory entries, the past experiences determined to be most impactful can be retained. Sparse Memory Attention 292 can include the NPCs recalling (e.g., selectively recalling) high-priority interactions, prioritizing memory recall efficiency, and the like. Rolling Memory Windows 294 can include low-impact historical data being cycled out (e.g., dynamically cycled out), mitigating excessive storage accumulation, and the like.

Slot-Based NPC Recycling 296 can relate to events in which an NPC ceases to exist within the game world. With such events, the Slot-Based NPC Recycling 296 can repurpose allocated memory footprints so that such allocated memory footprints may be used for newly generated entities. Using the allocated memory footprints can (e.g., can for newly generated entities) prevent or alleviate database fragmentation. NPC Personality & Memory Optimization 264 can result in NPC memory utilization being maintained within a 500MB per world state allocation, which can provide long-term behavioral continuity with minimal storage overhead.

The fourth stage of the AI model architecture 204 can include the Real-Time AI Decision-Making stage 266. The Real-Time AI Decision-Making stage 266 can provide an interaction (e.g., a dynamic interaction) processing and NPC behavioral evolution. The compression techniques used for the Real-Time AI Decision-Making stage 266 can include an Edge Inference+ 240, an Incremental Learning Storage 242, an Adaptive Caching Mechanism 244, an AI Latency Minimization 246, and the like. The Real-Time AI Decision-Making stage 266 can be executed offline due to the data used for the Real-Time AI Decision-Making stage 266 being optimized for performance. The Real-Time AI Decision-Making 266 can be executed on-device. The Real-Time AI Decision-Making 266 can include AI computations that can be conducted locally on a user’s (e.g., player's) hardware. By performing the AI computations on the player’s hardware, reliance on remote processing resources can be obviated.

Edge Interference 240 can include an on-device inference execution and workload arbitration layer within the Real-Time AI Decision-Making stage 266 of the AI model architecture 204. Edge Interference 240 can regulate an interference between AI inference workloads and real-time simulation workloads. In an embodiment, Edge Interference 240 can regulate an interference between AI inference workloads and real-time simulation workloads by applying context-driven filtering and resource allocation controls during run-time inference. Edge Interference 240 can receive decision-request packets in a structured format (e.g., FAIRequestContext) that can include one or more observations, world-state data, action queries, NPC identifiers, and/or engagement tier indicators.

Edge Interference 240 can route the packets to a local inference subsystem that can load a compressed model checkpoint and format an inference prompt from the packet contents. Edge Interference 240 can apply inference complexity controls aligned with the NPC Simulation System 302 tiers (e.g., Full AI Simulation 330, Hybrid AI Simulation 332, Background Simulation 334) by invoking full-detail inference for Tier 1 requests and appending a simplified inference control token for Tier 2 and Tier 3 requests, which can constrain computations for mid-range and distant NPCs and maintain continuity of behavior updates.

Edge Interference 240 can augment the inference prompt with per-NPC memory/personality context from the NPC memory system 308, execute inference, and/or return a model output that can include machine-readable action/state tokens that can be parsed into NPC behaviors and animations. Edge Interference 240 can store inference outcomes as memory updates and decision records supporting Incremental Learning Storage 242 and Adaptive Caching Mechanism 244, which can enable reuse of prior computations and reduce redundant inference for repeated or similar requests.

Incremental Learning Storage 242 can include AI decision logs that are structured in an evolving dataset. Structuring the logs in an evolving dataset may prevent redundant recalculations and expedite future inferences.

In an embodiment, the Adaptive Caching Mechanisms 244 can include frequently executed AI subroutines (e.g., combat maneuvers, trade negotiation frameworks, hierarchical faction dynamics) that can be preloaded into RAM. AI Latency Minimization 246 can include NPCs situated outside of a player's active engagement radius. The NPCs situated outside of the player's active engagement radius may be dynamically transitioned to a low-power state, which can optimize system resource allocation. The Real-Time AI Decision-Making stage 266 can reduce AI latency to imperceptible levels, which can facilitate real-time NPC responses and emergent world dynamics.

As shown in FIG. 2, the AI subsystem 200 can include an AI decision engine 206. The AI decision engine can be a high-efficiency engine. In embodiments, the AI decision engine 206 can enable real-time responsiveness without computational overhead penalties. In an embodiment, the AI decision engine 206 can be a runtime orchestration component within the AI subsystem 200 that can ingest a per-agent context packet (e.g., FAIRequestContext) and determine an execution plan. The execution plan can map the agent to an engagement tier of the NPC Simulation System 302 (e.g., Tier 1 Full AI Simulation 330, Tier 2 Hybrid AI Simulation 332, Tier 3 Background Simulation 334). The AI decision engine 206 can assign a bounded inference budget (e.g., latency target, token budget, and CPU/GPU allocation) and route the request to the appropriate inference path of the AI model architecture 204 and Real-Time AI Decision-Making stage 266, such as an edge-executed inference path (e.g., Edge Inference 240) and a cache-assisted path (e.g., Adaptive Caching Mechanism 244) for repeated routines, while reserving full-model reasoning for contexts that satisfy the tier and budget constraints.

The AI decision engine 206 can perform memory-aware prompting by retrieving one or more states (e.g., one or more agent-specific states) from the self-adaptive NPC memory system 308 (e.g., NPC Memory System 320 and Memory Retention System 322). When persistence is required, the AI decision engine 206 can coordinate reads/writes through the Offline Data Storage and Query Optimization 402 of the Optimization Subsystem 400 using structured storage for world/NPC records (e.g., SQLite 452), memory-mapped recall for high-frequency retrieval (e.g., LMDB 454), event journaling (e.g., Flat File Logging 456), and/or delta-based persistence (e.g., Incremental AI Saves 458) to maintain continuity without full state rewrites. The AI decision engine 206 can record decision traces in Incremental Learning Storage 242 to support reuse of prior resolutions and/or to avoid redundant re-computations. The AI decision engine 206 can emit a normalized action-and-dialogue directive (e.g., action tokens and state/mood tokens plus natural-language utterance text) that can be consumed by NPC control logic to trigger state machines, animations, and dialogue delivery while maintaining deterministic resource bounds across concurrently simulated agents in an offline deployment.

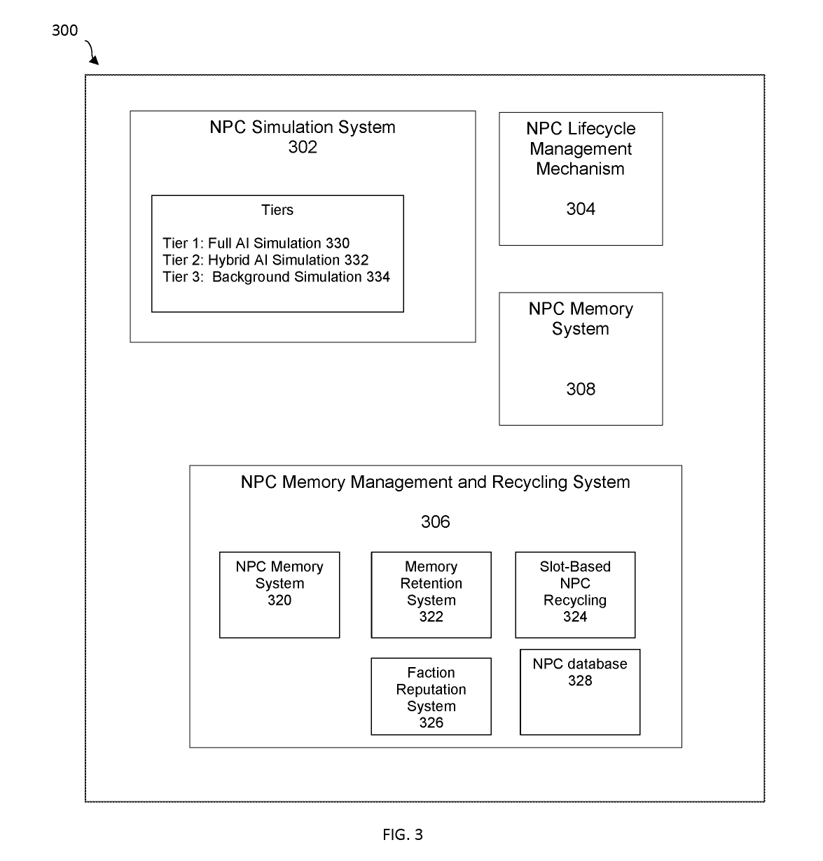

The system 100 can include one or more NPC subsystems, such as an NPC subsystem 300. As shown in FIG. 3, the NPC subsystem 300 can include an NPC Simulation System 302 that can optimize performance. In an example, open-world games can simulate two or more (e.g., all) NPCs simultaneously, which can lead to unmanageable CPU/GPU overhead, or can freeze NPCs when the NPCs are out of view. The freezing of NPCs can create inconsistencies in simulated world interactions. The NPC Simulation System 302 can adjust (e.g., dynamically adjust) the NPC behavior complexity based on the player’s proximity and interaction radius. By adjusting (e.g., dynamically adjusting) the NPC behavior complexity based on the player’s proximity and interaction radius, the NPC Simulation System 302 can provide computational efficiency while maintaining a persistent game world.

The NPC Simulation System 302 can be tiered. As shown in FIG. 3, in an embodiment the tiers of the NPC Simulation System 302 can include a Full AI Simulation 330 (Tier 1), a Hybrid AI Simulation 332 (Tier 2), and a Background Simulation 334 (Tier 3). The Full AI Simulation 330 can include real-time AI logic for NPCs near the player, the hybrid AI Simulation 332 can include probabilistic AI models for mid-range NPCs, and the background Simulation 334 can include binary event-driven updates for distant NPCs.

The NPC subsystem 300 can include an NPC lifecycle management mechanism 304 and a self-adaptive NPC memory system 308. The NPC lifecycle management mechanism 304 can facilitate world-state persistence while sustaining an optimal memory footprint. The NPC memory system 308 can be governed by dynamic retention and selective recall protocols.

NPC systems can forget previous interactions when a player leaves an area or may require excessive storage allocations that expand indefinitely which may lead to performance degradation. The NPC memory system 308 and the NPC Memory Management and Recycling System 306 can recall previous interactions of a player when they leave an area. The NPC Memory Management and Recycling System 306 can include one or more of an NPC Memory System 320, a Memory Retention System 322, a Slot-Based NPC Recycling 324, a Faction Reputation System 326, an NPC database 328, and the like.

The NPC memory system 320 can be a memory that is persistent and/or event-driven. In embodiments the NPC memory 320 can cause NPCs to learn, adapt, and dynamically change roles, which can be useful in an evolving simulated world, for example. The memory retention system 322 can provide NPCs the ability to recall past player interactions, including dialogue, emotional states, and behaviors. Slot-Based NPC Recycling 324 can repurpose a database, such as NPC database 328 (e.g., database of an NPC) when an NPC ceases to exist. In an embodiment, the NPC database 328, such as a slot in the database 328, can be repurposed for newly generated NPCs. The faction reputation system 326 can update the NPCs faction standings based on event propagation rather than omniscient knowledge.

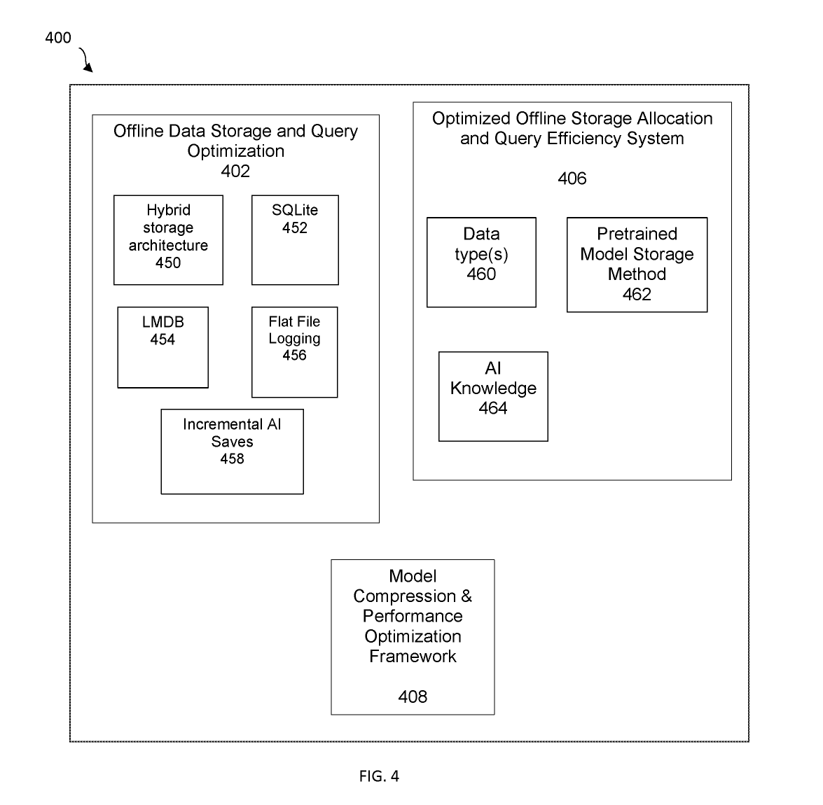

AI-driven NPCs may require extensive data storage and retrieval, which can slow performance due to frequent disk I/O, consume excessive storage, and create AI bottlenecks when multiple NPCs query decisions simultaneously. To account for the data storage and retrieval requirement, the system 100 can include an Optimization Subsystem 400. As shown in FIG. 4, the Optimization Subsystem 400 can include an Offline Data Storage and Query Optimization 402, an Optimized Offline Storage Allocation and Query Efficiency System 406, and a Model Compression & Performance Optimization Framework 408.

The Offline Data Storage and Query Optimization 402 can include a Hybrid storage architecture 450, an SQLite 452, a lightning memory mapped database (LMDB) 454, a Flat File Logging 456, and an Incremental AI Saves 458. The Hybrid storage architecture 450 can optimize structured and unstructured data retrieval, which can prevent or mitigate AI slowdowns while running offline. The SQLite 452 can include structured game data. In an embodiment, the SQLite 452 can manage NPC stats, quests, and faction standings, and can enable instant AI decision-making without requiring frequent disk reads. The LMDB 454 can include memory-mapped AI recall. The Flat File Logging 456 can include event-based AI updates. The Flat File Logging 456 can store world-state changes efficiently, which can reduce redundant processing. Incremental AI Saves 458 can write modified data (e.g., only modified data) rather than full state dumps, which can minimize storage overhead.

The Optimized Offline Storage Allocation and Query Efficiency System 406 can include data types, storage methods, and AI knowledge. For example, the Optimized Storage Allocation and Query Efficiency System 406 can include one or more data types 460 (e.g., a general AI Knowledge data type), a Pretrained Model (Compressed LLM) Storage Method 462, and AI Knowledge 464 that can be an indexed retrieval for low latency inference.

The Data type(s) 460 can include a Medieval-Specific AI Knowledge data type, a 3GB (LoRA-enhanced finetuning) Storage Method, and AI Knowledge that can include precomputed response caching that can minimize CPU load. In an embodiment, the data type(s) 460 can include an NPC Memory Data type, a 500MB (Sparse Memory Attention) Storage Method, and AI Knowledge that includes a selective data retrieval for efficient recall. The data type(s) 460 can include dynamic AI interaction data type(s), a RAM Cache (AI Edge Inference) Storage Method, and AI Knowledge that executes instantaneous decision making.

Pretrained Model (Compressed LLM) Storage Method 462 can store the compressed pretrained model as a local, on-device model artifact (e.g., a binary checkpoint file addressable by a local path) that can be loaded during initialization of an on-device model loader (e.g., UOfflineAIModelSubsystem) and retained via a model handle for run-time inference. The Pretrained Model (Compressed LLM) Storage Method 462 can include unload and lifecycle management during subsystem deinitialization (e.g., engine shutdown and/or level transition). AI Knowledge 464 can be persisted and retrieved through the Optimization Subsystem 400 using Offline Data Storage and Query Optimization 402 and Hybrid Storage Architecture 450 to implement an indexed knowledge base segmented by access pattern, in which structured simulation facts can be stored and queried in SQLite 452.

High-frequency NPC recall and memory records can be stored in LMDB 454 using deterministic keys (e.g., “NPC:<NPC_ID>” and timestamped event keys) to support direct key lookups. Chronological world-state change events can be appended via Flat File Logging 456 for replay and auditability. Session-to-session updates can be persisted using a base-plus-delta approach via Incremental AI Saves 458. During inference, the indexed retrieval layer can resolve the subset of AI Knowledge 464 relevant to the active request context (e.g., FAIRequestContext) and supply that resolved context to the run-time instance to preserve continuity while reducing repeated computation.

The Optimization Subsystem 400 can include a Model Compression & Performance Optimization framework 408. The Model Compression & Performance Optimization framework 408 is configured to provide optimal computational performance without degradation in functionality. In an exemplary embodiment, the Model Compression & Performance Optimization framework 408 can provide one or more of the following features: (1) Quantization Strategies that include FP8 deployment with structured tensor decompression techniques; (2) Architectural Pruning that includes dynamic attention-head reduction to optimize inference latency; (3) Mixture of Experts (MoE) Mechanism that includes dynamic expert activation to balance processing efficiency and resource allocation; and (4) Knowledge Distillation that includes hierarchical compression to facilitate model transferability across resource-constrained platforms.

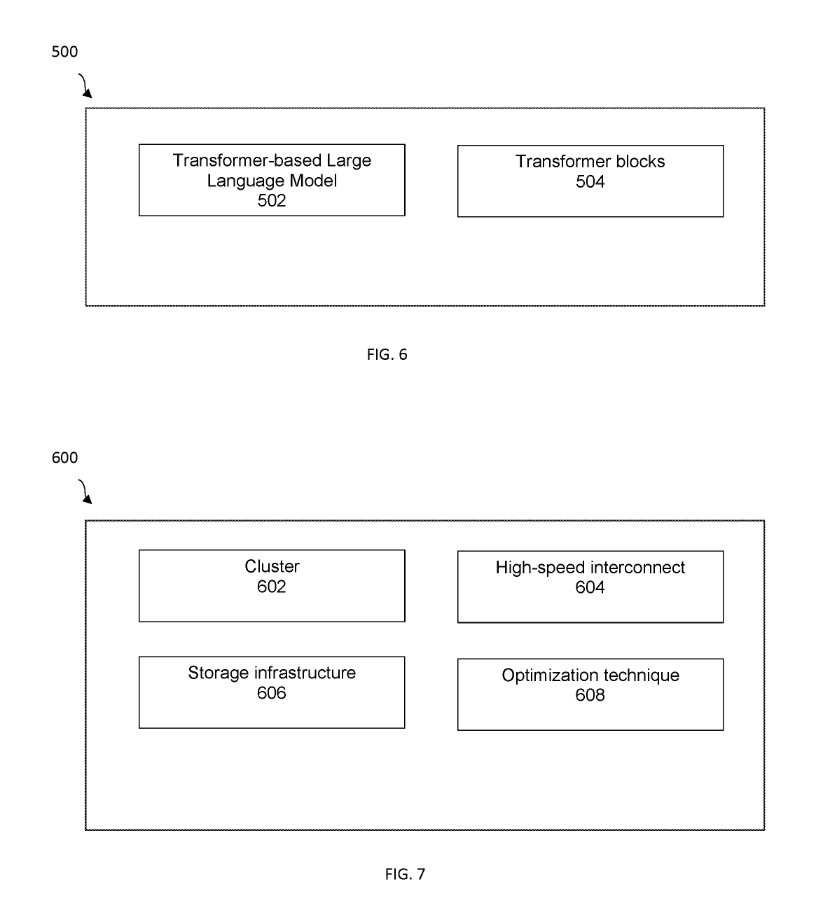

In an embodiment, the system 100 can include a Model Architecture 500. As shown in FIG. 6, the Model Architecture 500 can include a Transformer-based Large Language Model (LLM) 502 that can be optimized for multimodal reasoning and contextual inference. The Model Architecture 500 can include a decoder-only transformer that can leverage cross-domain adaptability across textual, visual, and/or auditory input streams. In an embodiment, the model architecture 500 can include a layer depth that has Transformer blocks 504, such as forty Transformer blocks 504. The Transformer blocks 504 can include enhanced inter-layer connectivity for improved reasoning.

The Model architecture 500 can include an embedded dimensionality that can facilitate high-resolution feature extraction and contextual encoding. The Model architecture 500 can include hidden state dimensionality that can enable complex pattern recognition within linguistic, visual, and auditory contexts. The Model architecture 500 can include an attention mechanism that can include a framework (e.g., a 32-headed self-attention framework) that can incorporate Global Query Attention (GQA) for refined computational efficiency. The Model architecture 500 can include rotary positional embeddings that can be configured at theta = 1M to support long-range dependencies within multi-turn interactions.

The Model architecture 500 can include a context window capacity having 128K tokens. The tokens can provide deep hierarchical contextual awareness and dynamic state retention. The Model architecture 500 can include a quantization methodology having a FP8 quantization for minimized VRAM usage and retaining near-lossless precision in response generation. The Model architecture 500 can include hardware that is optimized for NVIDIA H100, L40S, A100 GPUs, which can provide compatibility across high-performance computing clusters. The Model architecture 500 can include an inference mechanism that includes TensorRT-LLM integration to maximize real-time inferencing throughput. The Model architecture 500 can include a fine-tuning framework having a NVIDIA NeMo with DeepSpeed ZeRO optimizations that balances efficiency with adaptive learning scalability.

In an embodiment, the system 100 can include a Computational infrastructure, such as Computational Infrastructure 600. The Computational infrastructure 600 can be used for training. As shown in FIG. 7, the Computational infrastructure 600 can include a Cluster 602 that can include a multi-node DGX A100, where each node can comprise 8× A100 80GB GPUs. The Computational Infrastructure 600 can include a High-speed interconnect 604 that can include NVLink and InfiniBand for ultra-low-latency inter-GPU communication and distributed training. In an embodiment, the base model (e.g., compressed base model, described herein) can be parallelized. Parallelizing the base model (e.g., compressed base model) includes partitioning one or more transformer blocks across one or more graphic processing units (GPUs).

The base model can be compressed for one or more iterations and/or can be parallelized for one or more iterations. Parallelizing the base model (e.g., compressed base model) can include sharing model parameters and distributing inference computations across a plurality of processors using one or more model-parallel executions and data-parallel executions to reduce inference latency for generating the behavior responses. In an embodiment, a parallelization strategy can be included. The parallelization strategy can include a hybridized model and data parallelism that implements mixed precision (bfloat16 & FP8) to balance memory efficiency and computational accuracy.

The Computational Infrastructure 600 can include a storage infrastructure 606 that can include a 10PB NVMe SSD for high-speed dataset access and model checkpointing. Batch processing capacity can be provided that includes a dynamic allocation of up to 2048 sequences per batch that may be modulated by workload and resource constraints. The computational infrastructure 600 can include an optimization technique 608 that can include a standard and/or common technique for regularization in neural training (e.g., AdamW) that can include weight decay providing stable gradient propagation across extended training runs. Learning rate scheduling can be provided that includes a cosine annealing with warmup that provides improved convergence stability and generalization robustness.

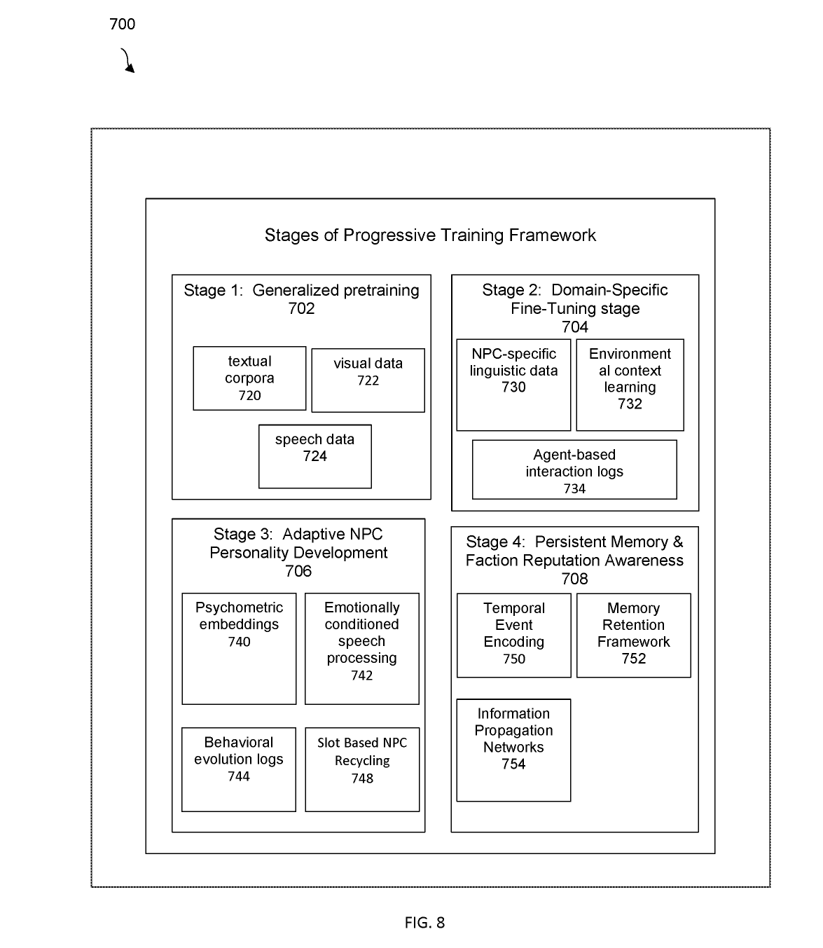

As shown in FIG. 1, the system 100 can include a Progressive Training Framework 700. FIG. 8 shows the Stages of the Progressive Training Framework 700, which can include four stages. Stage 1 of the progressive training framework 700 can include a Generalized pretraining 702 for foundational knowledge. The Generalized pretraining 702 can include a fundamental multimodal intelligence that can provide reasoning over textual, visual, and auditory stimuli while ensuring coherent world-state retention. Training Data for Stage 1 can include textual corpora 720, visual data 722, and speech data 724. The textual Corpora 720 can include structured domain-specific knowledge repositories (500B tokens), logic-based discourse data (15B tokens), and medieval-era linguistic artifacts (10B tokens). The Visual Data 722 can include LAION-5B, OpenAI CLIP datasets, and synthetic multimodal instruction-following datasets (150M instances). The Speech Data 724 can include CommonVoice multilingual speech-text alignments, phoneme-based dialect reconstruction datasets, and the like.

Stage 1 Generalized pretraining 702 can include a training process. The training process for Stage 1 Generalized pretraining 702 can include one or more of the following steps: (1) cross-attention augmentation for robust multimodal fusion; (2) self-supervised masked token prediction to reinforce contextual coherence; (3) contrastive loss optimization to refine image-language association embeddings; and (4) Phoneme-augmented speech synthesis alignment for improved interactive response fidelity.

Stage 2 of the progressive training framework 700 can include a Domain-Specific Fine-Tuning stage 704. In an embodiment, the Domain-Specific Fine-Tuning stage 704 may be provided for a Medieval Simulation. For example, the Domain-Specific Fine-Tuning stage 704 for Medieval Simulation may adapt a pretrained model to the Medieval Life: Chronicles of Annora environment, which can refine domain fidelity and contextual interplay between NPCs and environmental stimuli. Training Data for Stage 2 can include NPC-specific linguistic data 730, Environmental context learning 732, and Agent-based interaction logs 734. NPC-specific linguistic data 730 can include 5M manually curated medieval dialogues structured around game-specific social interactions. Environmental context learning 732 can include combat tactics, feudal economic simulations, and resource transaction models. Agent-based interaction logs 734 can include 100K+ simulated NPC engagements to refine emergent decision-making and situational adaptability.

Stage 2 Domain-Specific Fine-Tuning stage 704 can include a training process. The training process for Stage 2 Domain-Specific Fine-Tuning stage 704 can include one or more of the following steps: (1) supervised Fine-Tuning (SFT) to reinforce period-specific dialogue authenticity; (2) Reinforcement Learning with Human Feedback (RLHF) to refine context-aware behavioral responses; (3) Multi-Agent Simulation Learning, ensuring NPC interactions remain emergent and dynamic; and (4) Contextual Memory Integration for long-term NPC recall and continuity across gameplay sessions.

Stage 3 of the progressive training framework 700 can include an Adaptive NPC Personality Development 706. The Adaptive NPC Personality Development 706 can model a sophisticated NPC personality system that can introduce behavioral dynamism and evolving character traits. Training Data for Stage 3 can include Psychometric embeddings 740, Emotionally conditioned speech processing 742, Behavioral evolution logs 744, and a Slot Based NPC Recycling 748. In an embodiment, Psychometric embeddings 740 can include multi-dimensional personality modeling based on Big Five and D&D Alignment methodologies. Emotionally conditioned speech processing 742 can include conversations (e.g., 2 million annotated conversations) embedding emotional variation and response dependencies. Behavioral evolution logs 744 can include interactions, such as 50K+ high-dimensional social interactions structured within a dynamic NPC memory framework.

Stage 3 Adaptive NPC Personality Development 706 can include a training process. The training process for Stage 3 can include one or more of the following steps: (1) Reinforcement Learning-driven personality development within variable social contexts; (2) Adaptive role-based NPC modeling contingent on inter-NPC interactions and player engagement; and (3) AI-Supervised Emotional Calibration to ensure intra-NPC dialogue consistency and rational behavioral shifts.

Stage 4 of the progressive training framework 700 can include a Persistent Memory & Faction Reputation Awareness 708. The Persistent Memory & Faction Reputation Awareness 708 can implement an NPC memory system with progressive recall capabilities and faction-based world knowledge propagation. Training Data for Stage 3 can include Temporal Event Encoding 750, Memory Retention Framework(s) 752, and Information Propagation Networks 754. Temporal Event Encoding 750 can include state transitions, such as 200K+ simulated in-game world-state transitions analyzed for causality. Memory Retention Framework(s) 752 can include sparse memory attention mechanisms that provide optimal balance between recall accuracy and storage efficiency. Information Propagation Networks 754 can include graph-based reputation tracking that govern NPC-led knowledge dissemination.

Stage 4 Persistent Memory & Faction Reputation Awareness can include a training process. The training process for Stage 4 can include one or more of the following steps: (1) Hierarchical memory encoding for event impact assessment and NPC-driven rumor generation; (2) Controlled knowledge propagation within NPC social hierarchies that can ensure consistent information availability; and (3) Factional alignment simulations, reinforcing AI-driven player consequence tracking and dynamic faction perception evolution.

In an embodiment, the system 100 can include a Deployment & Execution Framework 800. As shown in FIG. 1, the Deployment & Execution Framework 800 can include a tiered AI execution paradigm, such as Tiered AI execution paradigms 802. The first tier can include a full computational simulation for NPCs 804. The full computational simulation for NPCs 804 can be performed in high-interaction regions. The second tier can include a probabilistic behavioral modeling for NPCs 806. The probabilistic behavioral modeling for NPCs 806 can be performed in peripheral locations. The third tier can include event-driven computational compression for NPCs 808. The event-driven computational compression for NPCs 808 can be performed in inactive states.

As shown in FIG. 1, the system 100 can include one or more Inference Engine Specifications 900. Inference Engine Specifications 900 can include a TensorRT-LLM with Triton Inference Server for optimal real-time execution and/or an Adaptive LoRA deployment, dynamically enabling memory-efficient specialization during runtime. The system 100 can include several features relating to AI-driven open-world gaming. Such features can include the ability to perform complex NPC decision-making, memory retention, and dynamic world evolution without a cloud-based architecture or an Internet connection. These features can provide a highly interactive, persistent game world experience while maintaining computational efficiency. As a result, the system 100 can provide advancements in offline AI gaming technology.

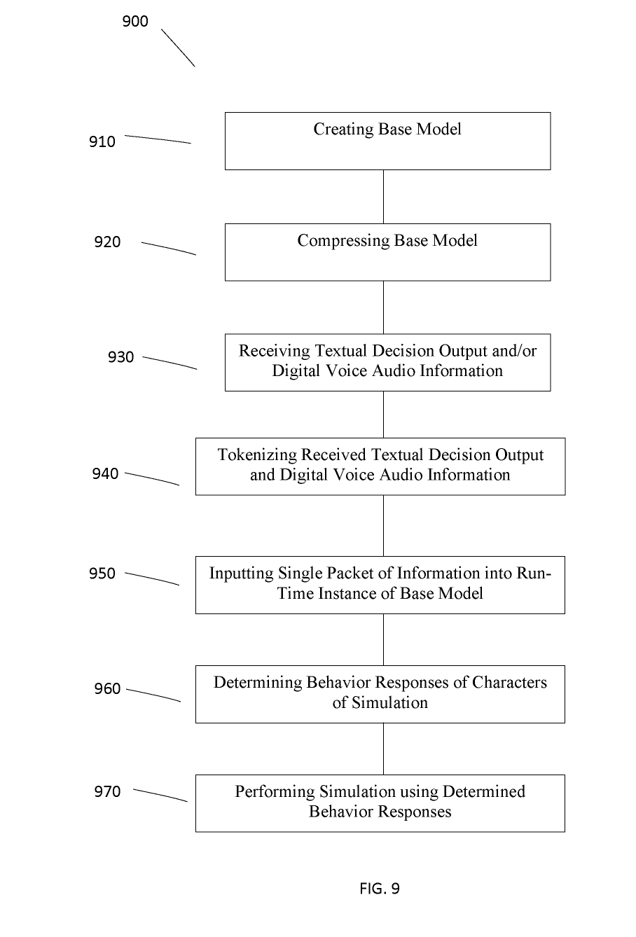

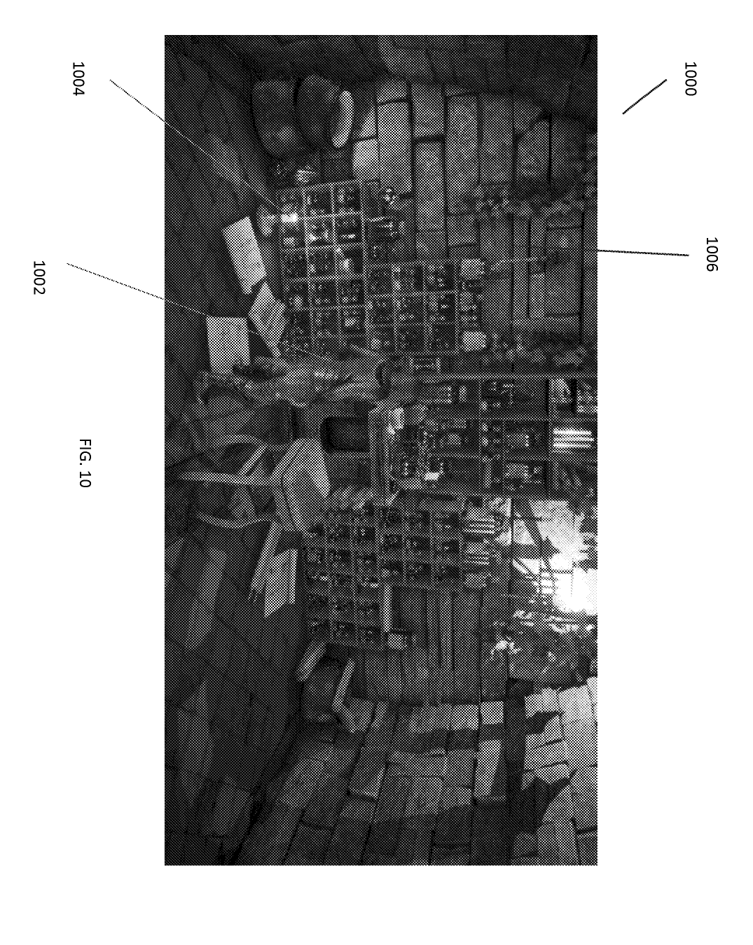

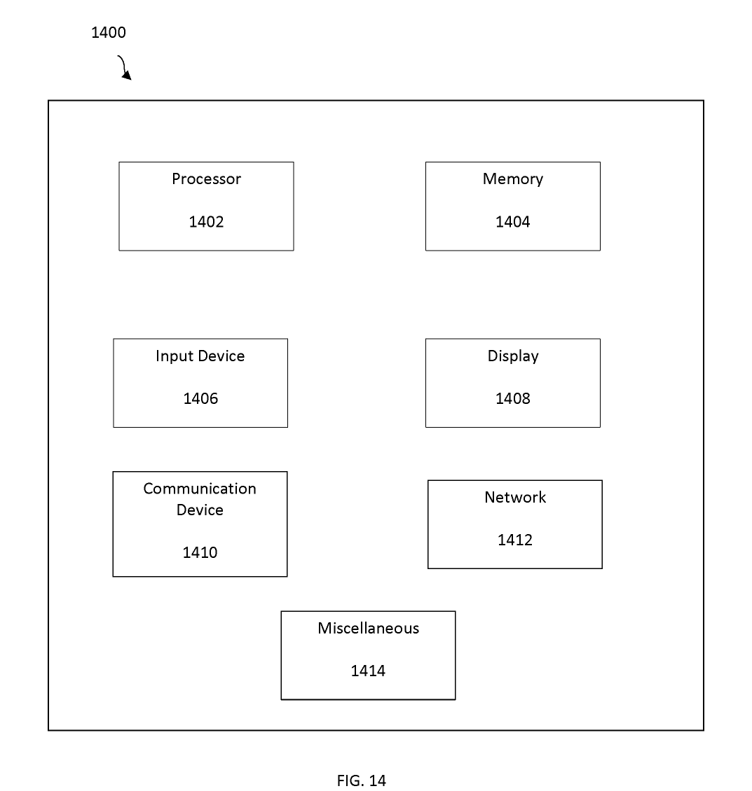

FIG. 9 shows an example method 900 of using system 100, according to embodiments described herein. The steps can be performed via one or more processors, such as processor 1402 (FIG. 14). Step 910 includes creating a base model. The base model can be created using data (e.g., simulation data) stored by memory, such as memory 1404. The base model may be created by one or more of determining an improved inference via a model distillation, determining an improved training via a low-rank adaptation (LoRA), determining a reduction in size of the model via a quantization, determining lower memory usage via a sparse attention, and determining activation costs via adaptive caching.

In determining an improved inference via a model distillation, the model distillation can be used to train a smaller model (e.g., a computationally efficient model) to mimic the behavior of a larger foundational model. The smaller model may be a surrogate model of the larger model and may mimic the behavior of the larger model without significant loss in reasoning accuracy. In an embodiment, the smaller model can learn to reproduce the outputs of the larger model via a comprehensive range of training inputs. The smaller model (e.g., the distilled model) can retain key cognitive capabilities of the larger model, such as contextual inference, multimodal fusion, and logical consistency, but the smaller model may include a smaller memory and computational footprint, which may be ideal for deployment in an offline environment and/or environments where resources are limited (e.g., an environment having 2GB or less of storage).

Determining an improved training via a LoRA can be used to preserve the original model's general intelligence and enhance its relevance to specific world models, thereby supporting high-fidelity behavioral realism in domain-constrained offline applications. Low-Rank Adaptation (LoRA) can be used to apply domain-specific fine-tuning to the distilled model without modifying its original parameters. For example, LoRA can introduce lightweight trainable matrices into specific weight layers and/or capture domain-dependent transformations with minimal overhead. In an embodiment, LoRA can enable efficient adaptation of a base model to medieval simulation content, and can encode historically contextual interactions, behaviors, and/or dialogue patterns without expanding the core architecture.

Determining a reduction in size of the model via a quantization can provide a real-time inference on edge devices, which can provide for the model’s responsiveness and operability in environments without access to high-performance compute clusters or cloud backends. In an embodiment, quantization can refer to reducing the precision of model weights and activations from standard 32-bit floating point to 8-bit or 4-bit representations, which can reduce the memory footprint and enable faster inference on consumer-grade GPUs. The architecture can use FP8 quantization, which can maintain near-lossless fidelity while dramatically reducing computational load and VRAM usage.

In determining lower memory usage via a sparse attention, sparse attention mechanisms can selectively activate attention heads or token relationships that are contextually relevant, which can prune (e.g., effectively prune) redundant computations in a self-attention process. This approach can significantly reduce the model’s computational complexity, especially during long-context inference tasks. In the offline AI architecture, sparse attention allows agents to focus only on salient environmental stimuli or critical memory cues when deciding behavior, leading to lower latency and improved scalability across thousands of simultaneously running agents.

In determining activation costs via adaptive caching, adaptive caching in an offline AI system can involve preloading frequently used inference subroutines and token patterns into RAM, which can cause the system to bypass full model computation for repeated or similar queries. In an example, adaptive caching can include commonly invoked behavioral routines, such as idle interactions, combat engagement heuristics, and/or economic decisions. Adaptive caching can be a dynamic technique. Adaptive caching can be prioritized based on recent or frequently accessed methods, which can cause efficient memory usage and can reduce I/O operations and latency. Adaptive caching can underpin the runtime efficiency of NPCs operating at Tier 2 and Tier 3, where detailed simulation can be unnecessary (e.g., unnecessary unless contextually escalated).

Step 920 includes compressing the base model. In an example, the base model can be compressed via weight clustering. The base model can be compressed through a multi-stage optimization pipeline involving distillation, pruning, LoRA fine-tuning, quantization, and sparse attention mechanisms. The one or more stages can incrementally reduce the model's size and compute requirements while preserving fidelity and domain specificity. This technique can result in a multi-gigabyte inference-ready model capable of performing complex reasoning tasks in real-time with minimal computational overhead. The compressed model (e.g., final compressed model) can be deployed on local systems without dependency on external servers, which can provide complete offline operation. Providing complete offline operation can be a critical requirement for simulation, defense, and field-deployed applications. In an embodiment, the compressed base model can be parallelized. Parallelizing the base model causes the base model to be as efficient at run time as possible. The compressing of the base model and the parallelizing of the compressed base model can be performed for multiple iterations. In an embodiment, the parallelizing of the compressed base model can include partitioning transformer blocks across multiple graphic processing units (GPUs).

Step 930 includes receiving textual decision output and/or digital voice audio information. The information received can correspond to real-time observational and environmental context data encapsulated in a structured format (e.g., FAIRequestContext). The information received can include sensory observations, such as a player approaching with a weapon drawn, world state variables (e.g., time of day, weather), a current action query (e.g., whether the NPC should greet or flee), and/or metadata such as the NPC's identity and engagement tier. Such information can be a packet of context that is tokenized and/or fed into the model to generate context-aware responses, which can facilitate emergent and realistic behavior across NPCs.

Step 940 includes tokenizing the received textual decision output and digital voice audio information. Tokening the received textual decision output and digital voice audio information can create a single packet of information and reduce frequent input/output rewrites. Within the Optimized Offline Storage Allocation and Query Efficiency System 406 of the Optimization Subsystem 400, the Pretrained Model (Compressed LLM) Storage Method 462 can store the pretrained inference model as a locally resident model checkpoint on non-volatile storage. The model checkpoint can be loaded and bound to a runtime model handle by the AI Subsystem 200 (e.g., via a game-runtime model loader such as UOfflineAIModelSubsystem) for on-device inference execution. AI Knowledge 464 can include an offline, indexed retrieval layer implemented by the Hybrid Storage Architecture 450 that binds (i) structured world-state records maintained in SQLite 452, (ii) high-throughput associative recall records and NPC memory summaries maintained in LMDB 454 and an NPC memory manager, and (iii) hot-path caches maintained by the Real-Time AI Decision-Making stage 266. Retrieved context snippets and decision-relevant facts can be merged into a structured request context (e.g., FAIRequestContext) prior to inference. Changes to the indexed knowledge can be persisted via Flat File Logging 456 and Incremental AI Saves 458 to maintain continuity across sessions.

Step 950 includes inputting the single packet of information, from step 940, into a run-time instance of the base model. In an embodiment, each run-time instance can have unique and isolated information from other run-time instances. For example, each run-time instance can have unique and/or isolated information from other run-time instances. Tokenizing the received textual decision output and the digital voice audio information can include generating (e.g., generating within the NPC subsystem 300) a structured request context (e.g., FAIRequestContext) that can include ordered fields for observations, world state(s), action queries, NPC identities, and/or engagement tiers. Within the AI subsystem 200, the fields can be serialized into a deterministic, delimiter-bounded sequence that can be mapped into embedding inputs for the compressed base model executed by the AI model architecture 204. The textual portion can be encoded using an embedding tokenizer that converts the serialized character stream and reserved control tags (e.g., section boundary tags and tier tags) into discrete token identifiers, positional indices, and attention masks used by the transformer’s shared internal caching, which can preserve field boundaries and enable deterministic downstream parsing of action/state tags. The audio portion can be received as digitized voice samples and can be encoded using the multimodal audio pathway of the model 140.

Speech-text alignments and phoneme augmentations can generate time-aligned acoustic/phonetic token identifiers in the model’s internal embedding space. The audio token identifiers can be associated with speaker metadata and timestamp metadata and can be aligned to corresponding text segments when a transcript is present. The system 100 can concatenate the text token identifiers and audio token identifiers into a single contiguous packet that can includes a header specifying modality layout, token counts, NPC_ID, tier flags, and timing data for the AI decision engine 206. The packet can be stored and referenced by Incremental Learning Storage 242 and Adaptive Caching Mechanism 244 in the Optimization Subsystem 400 to support repeated inference without re-encoding unchanged context.

Step 960 includes determining behavior responses of one or more characters of a simulation. In an exemplary embodiment, the behavior responses of one or more characters of a simulation can be determined based on the single packet of information input into the run-time instance. In other embodiments the behavior responses of one or more characters of a simulation can be determined based on a configured personality disposition (CPD). As used herein, a CPD can refer to a process of designing and establishing a specific, consistent persona for a conversational AI which can be used to create AI interactions appear more human-like, intuitive, and brand-consistent. The determined behavior responses of one or more characters of the simulation can be independently determined, although in other examples the behavior responses of one or more characters of the simulation can be based on other factors.

Step 960 can include determining behavior responses of one or more characters of a simulation. In an exemplary embodiment, the behavior response for each character can be determined from the single packet of information created in step 940 and input into a run-time instance in step 950. The single packet of information can include a short, structured description of (i) what the character can notice (e.g., what the character can see and hear), (ii) important facts about the situation (e.g., time of day, weather, nearby danger), and (iii) the decision that needs to be made (e.g., “what should I do next”).

The packet can be arranged as a request context (e.g., FAIRequestContext) including Observations, WorldState, ActionQuery, an identifier for the character (NPC_ID), and one or more tier indicators (e.g., Tier 1, Tier 2, and/or Tier 3) based on player distance or engagement. In an embodiment, the tier indicator can be used to decide whether the system 100 runs a full response (e.g., Tier 1), a lighter-weight response (e.g., Tier 2), or a background/event-driven response (e.g., Tier 3). In embodiments, the behavior response is further guided by a configured personality disposition (CPD), which can be used to keep the character’s choices and tone consistent over time (e.g., a shy person reacts differently than a bold person in the same situation).

In an embodiment, the system 100 can add the character’s stored memory (e.g., a short summary of prior events, relationships, and emotions) to the request so the response matches what the character recalls. The run-time instance of the base model can generate an AI response, and the AI response can be converted into simulation actions (e.g., movement, gestures, and dialogue). Relevant updates can be stored in memory for future behavior responses. For example, Character 1 – Basic Civilian Role (e.g., bystander, shopkeeper, villager). In an embodiment, determining a behavior response for a civilian character can include building the request context using information the civilian could reasonably notice and care about, such as safety, social rules, and routine tasks. For example, observations can include: “a person is walking toward me,” “the person is holding a weapon,” “a loud sound occurred nearby,” “guards are visible,” “the civilian is currently working,” and/or “the civilian is tired.” A worldstate can include one or more of the following: “time of day,” “weather,” “local danger level,” “whether a curfew is active,” and/or “how safe this area is.”

The ActionQuery can be simple and role-appropriate query, such as: “Decide whether to greet, ignore, step back, ask for help, run away, or keep working.” In an embodiment, when a civilian is near the player (e.g., Tier 1), the system 100 can generate a fuller, more detailed response (e.g., natural speech plus body language). When the civilian is farther away (e.g., Tier 2 or Tier 3), work can be reduced by using a simplified inference marker and/or choosing a smaller decision space (e.g., continue walking, glance around, move to a safer spot) and keeping the civilian’s behavior consistent. In an embodiment, the civilian’s memory summary (e.g., “the player helped me earlier,” or “the player threatened me last time”) can be retrieved and included with the request, so the civilian can react in a way that makes sense for that history. The AI response can be converted into game actions, for example by reading tagged outputs such as an action (e.g., greet or flee) and a mood (e.g., calm or scared), and the matching animation and dialogue can be triggered. After the action is taken, the system 100 can store a short memory update (e.g., “player approached with weapon; civilian became afraid; civilian ran; trust decreased”), and older, low-impact memories can be removed or summarized so the memory stays within a practical size. For example, Character 2 – Combat-Taught Field Commander (e.g., squad leader, platoon leader).

In an embodiment, determining a behavior response for a field commander can include building the request context using tactical observations, mission goals, and available resources, and one or more of the following can be produced: (i) the commander’s own movement/behavior, and (ii) orders for other characters. For example, observations can include one or more of: “enemy direction and distance,” “friendly team locations,” “incoming fire direction,” “available cover,” “ammo status,” “injured teammate status,” and/or “radio status.” WorldState can include: “current objective,” “rules of engagement,” “terrain type,” “visibility,” and/or “time pressure.” The ActionQuery can request a clear next step, such as: “Decide the next maneuver and issue orders to the team.” In an embodiment, when danger is imminent, fast and/or practical choices (e.g., take cover first, then coordinate) can be preferred, and commonly used combat routines can be cached or used to reduce delay.

In an embodiment, Tier behavior can apply. For example, Tier 1 commanders (near/engaged) can receive full decision depth, and Tier 2 and Tier 3 commanders can receive simplified or event-driven updates until escalation is needed. The AI response can be parsed into actions such as “take cover,” “move left,” and/or “suppress,” and into team orders such as “Team A hold position” and “Team B flank.” The simulation can apply these outputs by setting behavior states (e.g., behavior tree values), triggering animations, and/or sending derived requests to subordinate characters so each subordinate can decide how to carry out the order based on what that subordinate can personally see and hear. The commander’s memory can store outcomes (e.g., whether a flank worked), which can influence (e.g., gradually influence) future choices so the commander appears to learn which tactics are effective in similar situations. For example Character 3 – Command-and-Control / Policy-Making Character (e.g., leader, governor, operations chief).

In an embodiment, determining a behavior response for a command-and-control or policy-making character can include building a request context from summary reports and larger “big picture” facts, and outputting decisions that change world settings, resource allocation, and/or instructions to groups of characters. For example, observations can include one or more of: “reports of fighting in an area,” “resource shortages,” “public mood changes,” “requests from sub-leaders,” and/or “recent player actions that affected the faction.” WorldState can include: “available budget,” “available personnel,” “alliances/treaties,” “current alert level,” and/or “current faction standing values.” The ActionQuery can request decisions such as: “Decide whether to raise security, move guards, approve or deny a request, adjust rules of engagement, or send a public message.” In an embodiment, because a character may be far from the player, the system 100 can frequently run this character in Tier 2 or Tier 3, where updates happen when important events occur (e.g., a major report arrives, a reputation threshold changes, or a crisis starts), and can escalate to Tier 1 depth when the player directly engages the leader or when a high-impact event occurs.

The AI response can be converted into “policy directives,” such as raising an alert level, assigning personnel to a district, updating faction standing values, and generating a message that other characters can repeat. In an embodiment, the directives can be written into structured world state (e.g., faction standing and quest/task records) and propagated through event logging so other characters can respond based on shared updates rather than “magical” shared knowledge. The character’s memory can store the decision and the observed outcome (e.g., “curfew lowered unrest but hurt trade”), and the system 100 can summarize or remove low-impact items over time to keep storage bounded while preserving long-term continuity for important leadership decisions. Step 970 includes performing the simulation using the determined behavior responses.

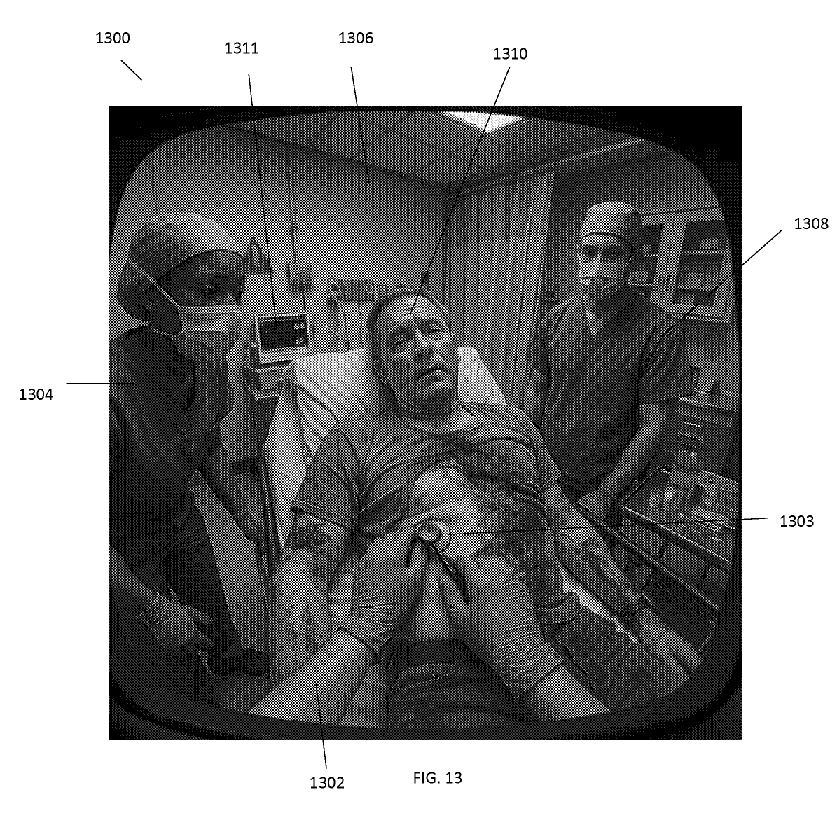

FIGS. 10-13 show screenshots of example simulations according to the system 100 as described herein. FIGS. 10 and 11 show screenshots 1000 and 1100 of interactions within a medieval world simulation, FIG. 12 shows a screenshot 1200 of combat arenas within a defense simulation, and FIG. 13 shows a screenshot 1300 of interactions within a medical simulation.

FIG. 10 shows a screenshot 1000 providing a simulation environment 1006 in which a player character, such as player character 1002 can be guided and/or controlled by a player, for example via an input device such as a keyboard, hand controller, voice detection apparatus, and the like. Although the simulation environment 1006 and player character 1002 relate to a medieval time period, it should be understood that such environment and character is for illustration purposes and the environment 1006 and player character 1002 can be from any time period and location, whether real or imaginary, as well from the past, present, or future time periods.

The player character 1002 can be completely controlled by a live person via a controller. For example, the controller can be used to move appendages of the player character 1002, such as the legs, arms, head of the player character 1002. The legs of the player character 1002 can be used to move the player character 1002 throughout scenes of the simulation, the hands of the player character 1002 can be used to manipulate objects found within simulation environment 1006, and the head of the player character 1002 can be used to simulate the player character 1002 looking in a particular direction, for instance.

In an embodiment, the system 100 can be used to provide behaviors of the player character 1002. The behaviors provided by system 100 can be used to in addition to the behaviors provided by the live person controlling the player character 1002. Example behaviors provided by the system 100 can include the blinking of the eyes of the player character 1002, the flinching of the player character 1002 when a noise or object appears near the player character 1002, a tripping of the player character 1002 over objects within the path of the player character 1002, a nodding of the head of the player character 1002 when the player character 1002 comes across another player within the simulation environment 1006, and so on. The system 100 can be used to provide emotional indicia of the player character 1002. Examples of emotional indicia can include smiling of the player character 1002 upon reaching a friend of the player character 1002 or a stranger to the player character 1002, frowning of the player character 1002 upon reaching an enemy of the player character 1002, grimacing of the player character 1002 if the player character 1002 experiences a painful activity, and so on.

The system 100 can be used to provide realistic actions of objects that are not players or non-player characters. For example, FIG. 10 shows candle 1004 having a flame. The system 100 can be used to provide realistic actions of the flame of candle 1004. For example, the system 100 can be used to provide flickering of the flame, reduction of the wick and lowering of the flame as the candle 1004 burns, and the like. Although simulation environment 1006 shows the candle 1004 as an object, such object is for illustration purposes only and is not intended to be limiting. The system 100 can be used to provide realistic actions for one or more objects within simulation environment 1006, such as vehicles, celestial objects (e.g., stars, planets, moons, asteroids, comets), animals, vegetation (e.g., trees, grass), and so on. For example, the system 100 can be used to provide the realistic movement of stars in the sky during the night, the realistic movement of the sun during the day, the realistic movement of horses running within a valley, and the like.

FIG. 11 shows a screenshot 1100 providing a simulation environment 1106 in which a player character, such as player character 1102 can be guided and/or controlled by a player, for example via an input device such as a keyboard, hand controller, voice detection apparatus, and the like. Although the simulation environment 1106 and player character 1102 are from a medieval time period, it should be understood that such environment and character is for illustration purposes and the environment 1106 and player character 1102 can be from any time period and location, whether real or imaginary, as well as in the past, present, or future.

The player character 1102 can be completely controlled by a live person via a controller. For example, the controller can be used to move appendages of the player character 1102, such as the legs, arms, head of the player character 1102. The legs of the player character 1102 can be used to move the player character 1102 throughout scenes of the simulation, the hands of the player character 1102 can be used to manipulate objects found within simulation environment 1106, and the head of the player character 1102 can be used to simulate the player character 1102 looking in a particular direction, for instance. In an embodiment, the system 100 can be used to provide behaviors of the player character 1102. The behaviors provided by the system 100 can be used to in addition to the behaviors provided by the live person controlling the player character 1102. Example behaviors provided by the system 100 can include the blinking of the eyes of the player character 1102, the flinching of the player character 1102 when a noise or object appears near the player character 1102, a tripping of the player character 1102 over objects within the path of the player character 1102, a nodding of the head of the player character 1002 when the player character 1102 comes across another player within the simulation environment 1106, and so on.

The system 100 can be used to provide emotional indicia of the player character 1102. Examples of emotional indicia can include smiling of the player character 1102 upon experiencing a pleasant experience, such as greeting a friend of the player character 1102 or a stranger to the player character 1102, frowning of the player character 1102 upon reaching an enemy of the player character 1102, grimacing of the player character 1102 if the player character 1102 experiences a painful activity, and so on.

Simulation environment 1106 can include one or more non-player characters (NPCs), such as NPC 1104 and 1108. The system 100 can be used to provide realistic movements, behaviors, interactions, emotions, and the like, of the NPCs 1104, 1108. Although simulation environment 1106 shows two NPCs from the medieval time period, it should be understood that such quantity of the NPCs and time period of simulation environment 1106 is for illustration purposes only. Embodiments of NPCs can include one or more NPCs from one or more time periods that can be based in reality or not based in reality.

The system 100 can be used to provide behaviors of the NPCs 1104, 1108. Example behaviors provided by the system 100 can include the blinking of the eyes of the NPCs 1104, 1108, the flinching of the NPCs 1104, 1108 when a noise or object appears near the NPCs 1104, 1108, a tripping of the NPCs 1104, 1108 over objects within the path of the NPCs 1104, 1108, a nodding of the head of the NPCs 1104, 1108 when the NPCs 1104, 1108 come across another player within the simulation environment 1006, and so on. The system 100 can be used to provide emotional indicia of the NPCs 1104, 1108. Examples of emotional indicia can include smiling of the NPCs 1104, 1108 upon reaching a friend of the NPCs 1104, 1108 or a stranger to the NPCs 1104, 1108, frowning of the NPCs 1104, 1108 upon reaching an enemy of the NPCs 1104, 1108, grimacing of the NPCs 1104, 1108 if the NPCs 1104, 1108 experiences a painful activity, and so on. The movements, behaviors, interactions, and emotions of the NPCs 1104, 1108 provided by the system 100 can be independent of one another.

The system 100 can be used to provide realistic actions of objects that are not players or non-player characters. For example, FIG. 11 shows a tent covering 1110. The system 100 can be used to provide realistic actions of the tent covering 1110. For example, the system 100 can be used to provide a movement of the tent covering 1110 due to wind, a movement of the tent covering 1110 as a result of a player character and/or NPC entering the tent, a movement of the tent covering 1110 as a result of the structure of the tent being compromised, and so on. Although environment 1106 shows the tent covering 1110 as an object, such object is for illustration purposes only and is not intended to be limiting. The system 100 can be used to provide realistic actions for one or more objects within simulation environment 1106, such as vehicles, celestial objects (e.g., stars, planets, moons, asteroids, comets), animals, vegetation (e.g., trees, grass), and so on. For example, the system 100 can be used provide the realistic movement of stars in the sky of simulation environment 1006 during the night, the realistic movement of the sun during the day, the realistic movement of horses running within a valley, and the like.

FIG. 12 shows a screenshot 1200 providing four simulation environments relative to four combat arenas, although such combat arenas are for illustration purposes only and one or more other combat areas, including one or more sub-combat arenas within the combat arenas shown on FIG. 12, can be provided in embodiments. As shown on FIG. 12, simulation environment 1201 relates to the air combat arena, simulation environment 1205 relates to the ground combat arena, simulation environment 1211 relates to the water combat arena, and simulation environment 1213 relates to the space combat arena. The simulation environments provided on FIG. 12 can be used for training purposes (e.g., to train military personnel on combat strategies), although in other examples the simulation environments can be used for entertainment purposes. In examples in which the simulation environments are provided for training purposes, the system 100 can provide details (e.g., classified details) to provide a realistic interaction with the simulation. Many of the features described relative to player characters and NPCs and FIGS. 10 and 11 can apply to FIG. 12.

Simulation environment 1201 is an air combat arena in which one or more jets, such as jets 1202, 1204, are flying in an airspace. In an example, jet 1202 can be a jet that is guided and/or controlled by a player, and jet 1204 can be controlled by system 100. A player can completely control jet 1202, although in other examples the player can control the jet 1202 and the system 100 can also provide some control of the jet, such as controlling the movement and/or behavior of the jet 1202. For example, a player can control the speed and/or direction of the jet 1202 and the system 100 can provide some movement of the jet, such as movement based on wind speed and the like. In an embodiment, the system 100 can fully guide the jet 1204, such as the direction, speed, and so on, of the jet 1204. The movement of the jet 1204 provided by system 100 can be unpredictable, which can provide the player controlling jet 1202 a realistic simulation to perform training within the air combat arena. Although simulation environment 1201 shows jets, such depiction is for illustration purposes and is not intended to be limiting. In other embodiments the simulation environment 1201 can include structures, other aircraft, vehicles, celestial objects, animals (e.g., birds), and the like.

Simulation environment 1205 is a ground combat arena in which one or more ground troops, such as troops 1206, 1208, are performing ground maneuvers. In an example, trooper 1206 can be a trooper that is guided and/or controlled by a player, and trooper 1208 can be controlled by the system 100. A player can completely control trooper 1206, although in other examples the player can control the trooper 1206 and the system 100 can also provide some control of the trooper, such as controlling the movement, behavior, and/or emotions of the trooper 1206. For example, a player can control the direction in which the trooper 1206 moves as well as the manipulation of a weapon held by the trooper 1206, and the system 100 can provide some behaviors and/or emotions of the trooper, such as a frown if the trooper 1206 encounters an unpleasant experience.

In an embodiment, the system 100 can fully guide the trooper 1208, such as the direction, speed, behavior, emotion, and so on, of the trooper 1208. The movement of the trooper 1208 provided by the system 100 can be unpredictable, which can provide the person controlling trooper 1206 a realistic simulation to perform training within the ground combat arena. Although simulation environment 1205 shows troopers, such depiction is for illustration purposes and is not intended to be limiting. In other embodiments the simulation environment 1205 can include enemy combatants, civilians, structures, vehicles (e.g., tanks, automobiles), celestial objects, animals (e.g., dogs), and the like.

Simulation environment 1211 is a water combat arena in which one or more warships, such as warship 1210 and 1212, are maneuvering within a water combat arena. In an example, warship 1210 can be a ship that is guided and/or controlled by a player, and warship 1212 can be controlled by the system 100. A player can completely control warship 1210, although in other examples the player can control the warship 1210 and the system 100 can also provide some control of the ship, such as controlling the movement and/or behavior of the warship 1210. For example, a player can control the speed and/or direction of the warship 1210 and the system 100 can provide some movement of the ship, such as movement based on wind speed and the like.

In an embodiment, the system 100 can fully guide the warship 1212, such as the direction, speed, and so on, of the warship 1212. The movement of the warship 1214 provided by the system 100 can be unpredictable, which can provide the person controlling warship 1210 a realistic simulation to perform training within the water combat arena. Although simulation environment 1211 shows warships, such depiction is for illustration purposes and is not intended to be limiting. In other embodiments the simulation environment 1201 can include structures (e.g., buoys), other ships, aircraft, celestial objects, animals (e.g., dolphins), mines, submarines, and the like.

Simulation environment 1213 is a space combat arena in which one or more satellites, such as satellite 1214, is maneuvering within a space combat arena. In an example, satellite 1214 can be a satellite that is guided and/or controlled by a player. A player can completely control satellite 1214, although in other examples the player can control the satellite 1214 and the system 100 can also provide some control of the satellite, such as controlling the movement and/or behavior of the satellite 1214. For example, a player can control the speed and/or direction of the satellite 1214 and the system 100 can provide some movement of the satellite, such as movement based on objects within space and the like.

In an embodiment, the system 100 can fully guide the satellite 1214, such as the direction, speed, and so on, of the satellite 1214. The movement of the satellite 1214 provided by the system 100 can be unpredictable, which can provide a realistic simulation to perform training within the space combat arena. Although simulation environment 1213 shows a satellite, such depiction is for illustration purposes and is not intended to be limiting. In other embodiments the simulation environment 1213 can include structures (e.g., a space station), other satellites, celestial objects, rocket ships, debris, and the like.

FIG. 13 shows a screenshot 1300 providing a medical simulation environment 1306 in which a player character, such as player character 1302 can be guided and/or controlled by a player, for example via an input device such as a keyboard, hand controller, voice detection apparatus, and the like. Although the simulation environment 1306 and player character 1302 are within an emergency room, it should be understood that such environment and character is for illustration purposes and the environment 1306, the player character 1302, and the like can be from any medical location, such as a doctor’s office, ambulance, operating room, street, home, and the like.

The player character 1302 can be completely controlled by a live person via a controller. For example, the controller can be used to move appendages of the player character 1302, such as the arms, fingers, legs, and head of the player character 1302. The hands and/or fingers of the player character 1302 can be used to manipulate objects found within simulation environment 1306, such as medical instruments 1303. Example medical instruments 1303 can include a stethoscope, endoscope, scalpel, scanning device, diagnostic device, and the like. The hands and/or fingers of the player character 1302 can be used to manipulate objects found within simulation environment 1306 to perform medical procedures.

In an embodiment, the system 100 can be used to provide behaviors of the player character 1302. The behaviors provided by the system 100 can be used to in addition to the behaviors provided by the live person controlling the player character 1302. Example behaviors provided by the system 100 can include the blinking of the eyes of the player character 1302, the flinching of the player character 1302 when a noise or object appears near the player character 1302, a physical action (such as a sneeze, cough, or the like) that occurs to the player character 1302, a nodding of the head of the player character 1302 when the player character 1302 comes across another player within the simulation environment 1306, a spasm or tiredness of one or more appendages, and so on.

The system 100 can be used to provide emotional indicia of the player character 1302. Examples of emotional indicia can include a smiling of the player character 1302 upon the player character 1302 greeting a patient (such as patient 1310) or performing a medical procedure successfully, a frowning of the player character 1302 upon performing a medical procedure unsuccessfully, a grimacing of the player character 1302 if the player character 1302 performs a medical procedure for an extended period of time, and so on.

Simulation environment 1306 can include one or more non-player characters (NPCs), such as medical NPC 1304, medical NPC 1308, and patient NPC 1310. The system 100 can be used to provide realistic movements, behaviors, interactions, emotions, and the like, of the NPCs 1304, 1308, 1310. Although simulation environment 1306 shows three NPCs from within an emergency room, it should be understood that such quantity of NPCs and location of the NPCs are for illustration purposes only. Embodiments of NPCs can include one or more medical and/or patient NPCs within one or more locations, as well as one or more other NPCs, such as family members of a patient NPC 1310, supervisors of player character 1302, and the like.

The system 100 can be used to provide behaviors of the NPCs 1304, 1308, 1310. Example behaviors and emotions provided by the system 100 can include the blinking of the eyes of the NPCs 1304, 1308, 1310, the flinching of the NPCs 1304, 1308, 1310 when a medical procedure is performed incorrectly, a nodding of the head of the medical NPCs 1304, 1308 when the medical procedure is performed correctly, a grimacing of the face of the patient NPC 1310 when a painful medical procedure is being performed, and so on. The system 100 can be used to provide emotional indicia of the NPCs 1304, 1308, 1310. The movements, behaviors, interactions, and emotions of the NPCs 1304, 1308, 1310 provided by the system 100 can be independent of one another.

The system 100 can be used to provide realistic actions of objects that are not players or non-player characters. For example, FIG. 13 shows a patient monitor 1311. The system 100 can be used to provide realistic information to be displayed on the patient monitor 1311, such as the vital signs of the patient NPC 1310. The vital signs can include one or more of the heart rate, blood pressure, oxygen saturation, and respiration rate of the patient NPC 1310. For example, the system 100 can be used to provide an increase in the blood pressure shown on the patient monitor 1311 if the patient NPC 1310 is experiencing distress during a medical procedure being performed by the player character 1302. The system 100 can be used to provide realistic actions for one or more objects within simulation environment 1306, such as curtains being moved, medical instruments dropping to the floor, hospital beds unintentionally moving, an unexpected spike in blood pressure of the patient NPC 1310, and so on.

FIG. 14 illustrates an example block diagram of a component system 1400 for performing a simulation according to the system 100 and embodiments described herein. The component system 1400 can include one or more of a processor 1402, a memory 1404, an input device 1406, and a display 1408. The system 1400 can include other devices, such as a communication device 1410, a network 1412, and a miscellaneous 1414. One or more of the devices of the system 1400 can be found within a single device, although in other embodiments one or more devices of the system 1400 can be distributed across multiple devices.

The processor 1402 can be a CPU, GPU, HPU, and the like. The processors 1402 can be a single processing unit or multiple processing units in a device or distributed across multiple devices. The processor 1402 can be coupled to other hardware devices, for example, with the use of a bus, such as a PCI bus or SCSI bus. The system 1400, via the processor 1402, can create a model (e.g., a base model). In an exemplary embodiment, the processor 1402 can obtain and/or generate data relating to the playing characters and non-player characters (NPCs). The base model can be modified based on the obtained and/or generated data relating to the playing characters and non-player characters (NPCs).

The memory 1404 can include one or more of various hardware devices for volatile and non-volatile storage, and can include both read-only and writable memory. For example, the memory 1404 can comprise random access memory (RAM), various caches, CPU registers, read-only memory (ROM), and writable non-volatile memory, such as flash memory, hard drives, floppy disks, CDs, DVDs, magnetic storage devices, tape drives, device buffers, and so forth. The memory 1404 can include program memory that stores programs and software, such as an operating system, and application programs. As described herein, the memory 1404 can receive and store one or more of data relating to a simulation (e.g., simulation data). In an example, simulation data can include data relating to one or more player characters, non-player characters, and so on. The processor 1402 and memory 1404 can be in operative communication with one another.

The input device 1406 can include, for example, a mouse, a keyboard, a touchscreen, an infrared sensor, a touchpad, a wearable input device, a camera- or image-based input device, a microphone, or other user input devices. The system 1400 can include a display 1408 that can be used to display text, models, virtual procedures, surgical plans, implants, graphics, and/or images. In some embodiments, the display 1480 can provide graphical and textual visual feedback to a user. In some implementations, the display 1408 can include one or more devices, such as the input device 1408, such as when the input device 1408 is a touchscreen or is equipped with an eye direction monitoring system. In some embodiments, the display 1408 can be separate from the input device 1408. Examples of display devices include an LCD display screen, an LED display screen, a projected, holographic, or augmented reality display (such as a heads-up display device or a head-mounted device), and so on.

In some embodiments, the 1400 can include a communication device 1410, such as a network device, which may enable system 100 to communicate with one or more external devices, although other embodiments may not include a communication device 1410. Communication device 1410 may enable system 1400 to communicate with one or more external devices wirelessly or via a wire. The communication device 1410 can communicate with an external device via network 1412. In embodiments, network 1412 can be the Internet, although the system 1400 can communicate data relating to a simulation to and from the system 1400 via any known wired or wireless communication protocol. For example, data relating to the simulation may be transmitted from the system 1400 to one or more systems via communication device 1410 and network 1412.

The system 1400 may include one or more miscellaneous devices 1414, such as a network card, video card, audio card, USB, firewire or other external device, camera, printer, speakers, CD-ROM drive, DVD drive, disk drive, Blu-Ray device, and the like. Other miscellaneous devices 1414 can include input ports for information from directly connected gaming equipment, such as virtual reality headsets and eyewear, motion sensing apparatuses, and the like.

It will be appreciated by those skilled in the art that changes could be made to the various aspects described above without departing from the broad inventive concept thereof. It is to be understood, therefore, that the subject application is not limited to the particular aspects disclosed, but it is intended to cover modifications within the spirit and scope of the subject application as defined by the appended claims.

We claim:

1. A multi-tiered Artificial Intelligence (AI) model compression system comprising:
a memory configured to store simulation data of a simulation, wherein the stored simulation data comprises data relating to at least one player character and non-player character;
a processor configured to:
create a base model of the simulation using the stored simulation data;
compress the base model of the simulation via a weight clustering of trained parameter weights of the base model generated from the stored simulation data;
receive textual and audio information relating to the simulation from at least one of (i) a simulation engine executing the simulation and (ii) a user input device;
tokenize the received textual and audio information to create a packet of information of the received textual and audio information;
input the packet of information into a run-time instance of the base model of the simulation;
determine behavior responses of the at least one player character and non-player character based on the packet of information input into the run-time instance of the base model; and
perform the simulation using the determined behavior responses.

2. The system of claim 1, wherein the base model of the simulation is created via at least one of determining an efficient inference via a model distillation, determining efficient training via a low-rank adaptation (LoRA), determining reduced size via a quantization, determining lower memory usage via a sparse attention, and determining activation costs via adaptive caching.

3. The system of claim 1, wherein the processor is further configured to parallelize the compressed base model, wherein the parallelizing of the compressed base model comprises sharing model parameters and distributing inference computations across a plurality of processors using at least one of model-parallel execution and data-parallel execution to reduce inference latency for generating the behavior responses.

4. The system of claim 3, wherein the compressing of the base model of the simulation and the parallelizing of the compressed base model are performed for multiple iterations.

5. The system of claim 3, wherein the parallelizing of the compressed base model comprises partitioning transformer blocks across multiple graphic processing units (GPUs).

6. The system of claim 1, wherein each of the behavior responses of the one or more characters of the simulation are independently determined.

7. The system of claim 1, wherein the run-time instance of the base model of the simulation has information that is unique and isolated from other run-time instances of the simulation.

8. The system of claim 1, wherein the tokenizing of the received textual and audio information creates a single packet of information of the received textual and audio information.

9. The system of claim 1, wherein the processor is configured to determine behavior responses of the at least one player character and non-player character based on the packet of information input into the run-time instance of the base model of the simulation.

10. The system of claim 1, wherein the weight clustering comprises assigning multiple neural node weights to clusters each represented by a shared centroid weight value.

11. The system of claim 1, wherein the textual and audio information correspond to utterances and context data of the at least one player character and non-player character, the utterances and context data comprising observations, world state variables, and requested actions of the at least one player character and non-player character.

12. A computer-implemented method comprising:
storing simulation data of a simulation, wherein the stored simulation data comprises data relating to at least one player character and non-player character;
creating a base model of the simulation using the stored simulation data;
compressing the base model of the simulation via a weight clustering of trained parameter weights of the base model generated from the stored simulation data;
receiving textual and audio information relating to the simulation from at least one of (i) a simulation engine executing the simulation and (ii) a user input device;
tokenizing the received textual and audio information to create a packet of information of the received textual and audio information;
inputting the packet of information into a run-time instance of the base model of the simulation;
determining behavior responses of the at least one player character and non-player character based on the packet of information input into the run-time instance of the base model; and
performing the simulation using the determined behavior responses.

13. The computer-implemented method of claim 12, further comprising parallelizing the compressed base model, wherein the parallelizing of the compressed base model comprises sharing model parameters and distributing inference computations across a plurality of processors using at least one of model-parallel execution and data-parallel execution to reduce inference latency for generating the behavior responses.

14. The computer-implemented method of claim 13, wherein the compressing of the base model of the simulation and the parallelizing of the compressed base model are performed for multiple iterations.

15. The computer-implemented method of claim 13, wherein the parallelizing of the compressed base model comprises partitioning transformer blocks across multiple graphic processing units (GPUs).

16. The computer-implemented method of claim 12, wherein each of the behavior responses of the one or more characters of the simulation are independently determined.

17. A non-transitory computer readable medium for use on at least one computer system containing computer-executable programming instructions for performing a method comprising:
storing simulation data of a simulation, wherein the stored simulation data comprises data relating to at least one player character and non-player character;
creating a base model of the simulation using the stored simulation data;
compressing the base model of the simulation via a weight clustering of trained parameter weights of the base model generated from the stored simulation data;
receiving textual and audio information relating to the simulation from at least one of (i) a simulation engine executing the simulation and (ii) a user input device;
tokenizing the received textual and audio information to create a packet of information of the received textual and audio information;
inputting the packet of information into a run-time instance of the base model of the simulation;
determining behavior responses of the at least one player character and non-player character based on the packet of information input into the run-time instance of the base model; and
performing the simulation using the determined behavior responses.

18. The non-transitory computer readable medium of claim 17, further comprising parallelizing the compressed base model, wherein the parallelizing of the compressed base model comprises sharing model parameters and distributing inference computations across a plurality of processors using at least one of model-parallel execution and data-parallel execution to reduce inference latency for generating the behavior responses.

19. The non-transitory computer readable medium of claim 18, wherein the compressing of the base model of the simulation and the parallelizing of the compressed base model are performed for multiple iterations.

20. The non-transitory computer readable medium of claim 17, wherein the tokenizing of the received textual and audio information creates a single packet of information of the received textual and audio information.
